(19) United States
(12) Patent Application Publication
(10) Pub. No.: US 2026/0116700 A1
(43) Pub. Date: Apr. 30, 2026

(54) MULTIPHASE TRACTION ELEVATOR CONTROLLER AND METHOD OF USE

(71) Applicant: Smartrise Engineering, Inc., Irving, TX (US)

(72) Inventors: Gilbert Zogbi, Irving, TX (US); Keith Soneda, Oakland, CA (US)

(73) Assignee: Smartrise Engineering, Inc., Irving, TX (US)

(21) Appl. No.: 19/432,678

(22) Filed: Dec. 24, 2025

Related U.S. Application Data
(63) Continuation-in-part of application No. 18/798,251, filed on Aug. 8, 2024.
(60) Provisional application No. 63/518,245, filed on Aug. 8, 2023.

(51) Int. Cl. B66B 1/28; B66B 1/34

(52) U.S. Cl. CPC B66B 1/285; B66B 1/3492

(57) ABSTRACT

A multiphasic traction elevator control system is disclosed, incorporating an advanced S-curve motion profile to optimize ride comfort, energy efficiency, and mechanical durability. The system features a central controller, a motor room board, and car and hall panel controllers communicating via a high-speed serial interface. A motion planning module dynamically calculates acceleration, cruising, and deceleration phases, adapting real-time speed adjustments to enhance efficiency. The system supports multiple operational profiles, including normal, short-distance, emergency power, and inspection modes, each with optimized jerk and velocity constraints. A mid-flight destination adjustment algorithm modifies motion profiles without abrupt speed changes. A stop rejection mechanism prevents unsafe or inefficient stops. Real-time speed monitoring in the inspection profile ensures precise velocity control. A precision floor leveling algorithm enhances stopping accuracy. The invention provides a high-speed, intelligent, and adaptive elevator control system, reducing mechanical wear while ensuring passenger safety and comfort.

### CROSS-REFERENCE TO RELATED APPLICATIONS

This application is a continuation-in-part of U.S. application Ser. No. 18/798,251 filed on Aug. 8, 2024 which claims priority benefit from U.S. Provisional Application No. 63/518,245, filed on Aug. 8, 2023. The patent applications identified above are incorporated here by reference in their entirety to provide continuity of disclosure.

### FIELD OF THE INVENTION

The present invention relates to elevator control systems, specifically those employing advanced algorithms to enhance the ride quality, efficiency, and durability of traction elevator systems. This invention addresses the need for smoother acceleration and deceleration profiles to improve passenger comfort and reduce mechanical wear, in a number of specialized situations.

### BACKGROUND OF THE INVENTION

Traction elevator systems represent a sophisticated segment of vertical transportation technology, leveraging advanced control mechanisms to deliver efficient and smooth travel between floors. These systems typically utilize a counterweight, ropes, and a motor-driven traction sheave to move the elevator car.

Traction elevators offer several advantages over other types of elevator systems, such as hydraulic elevators, including energy efficiency, speed, and capacity. They generally consume less power, particularly in high-rise buildings where counterweighting can significantly reduce the energy required to move the elevator car. They are capable of higher speeds and greater travel distances, making them suitable for tall buildings.

Over recent decades, advancements in control technologies, such as variable voltage, variable frequency drives, and digital speed pattern generators, have significantly enhanced the performance and reliability of traction elevators. Modern elevator systems, particularly those employing traction drive mechanisms, now rely heavily on sophisticated control algorithms to manage acceleration and deceleration.

U.S. Pat. No. 4,155,426 to Booker, Jr. and U.S. Pat. No. 5,035,301 to Skalski, illustrate the evolution of control systems from basic mechanical methods to highly sophisticated digital control techniques.

Despite these advances, modern elevator control systems still face several challenges, particularly related to the smoothness of the ride and the durability of the mechanical components. For example, traditional control systems often produce high jerk values, leading to a jarring experience for passengers and increased wear on mechanical components. The mechanical stress resulting from inefficient speed control can lead to accelerated wear and tear on critical components, such as the motor, brakes, and traction sheave. This not only reduces the lifespan of the equipment but also increases maintenance costs and downtime. Achieving accurate stopping and positioning is crucial for passenger safety and system reliability. Traditional systems also struggle with precise control during emergency and inspection situations, leading to floor leveling inaccuracies and potential safety hazards.

There have been many attempts in the prior art to address these problems using various control techniques. For example, patents such as U.S. Pat. No. 4,553,640 to Inaba, et al. and European Patent No. EP2602221B1 to Konig, address the problems associated with rough rides caused by abrupt changes in acceleration and deceleration.

U.S. Pat. No. 4,155,426 Booker, Jr. discloses an elevator control system employing a variable voltage, variable frequency approach to maintain consistent speed under varying load conditions. The system generates a first digital speed pattern signal from a pulse train with a constant average pulse rate and a second digital speed pattern signal during deceleration, responsive to the elevator's distance from the desired stopping point. The speed pattern signal adjusts between zero and a predetermined maximum value within predefined jerk and acceleration constraints.

U.S. Pat. No. 6,202,796 to Lee, discloses a method for controlling an elevator car's position by generating a velocity command signal to follow a velocity pattern. The elevator system features an encoder that provides pulse signals corresponding to the motor's rotation and a way to calculate the distance traveled by the elevator car based on the encoder's pulse signals.

European Patent No. EP2602221B1 to Konig discloses a method for controlling the movement of a load, such as an elevator, via a computer-readable medium with executable instructions. The load, connected to a drive controlled by a controller, follows a predetermined movement routine with a nominal speed and a creep speed. The controller issues a deceleration command to the drive when the load's current position and the creep position distance equals the acceleration and deceleration distances.

U.S. Pat. No. 4,553,640 to Inaba, et al., discloses an elevator controller that includes a peripheral interface adaptor for interfacing the CPU with external digital signals, a programmable timer module for detecting acceleration and velocity by counting pulses from a rotary encoder, a bus for address and data transfer, a digital-to-analog converter, and an analog-to-digital converter. The controller features a rotary encoder for generating pulses based on car travel distance. The system generates acceleration commands for the elevator car and directly controls the motor. The acceleration command generation comprises a gradually increasing acceleration start mode, a constant acceleration mode, and a gradually decreasing acceleration reduction mode. Transitions between these modes are based on specified conditions, such as the car's acceleration reaching a specified value and the actual velocity approaching the desired velocity.

U.S. Pat. No. 5,035,301 to Skalski, discloses an elevator speed dictation system that controls the acceleration and deceleration of an elevator. The system uses a table to store acceleration, velocity, and position values. Upon issuing a stop control command, the system employs a distance error calculation based on the dictated position and the actual distance traveled.

Advancements in traction elevator control systems have significantly improved the efficiency, safety, and comfort of vertical transportation. However, prior art systems still face challenges related to accurately controlling elevator motion during varied operating conditions. The innovations described in this disclosure provide sophisticated solutions to these problems through advanced digital control techniques and optimized acceleration and deceleration profiles.

### SUMMARY OF THE INVENTION

The present invention relates to a multiphasic traction elevator control system designed to optimize ride quality, energy efficiency, and mechanical durability through the implementation of advanced digital control algorithms. This system employs an adaptive S-curve motion profile, which dynamically adjusts acceleration, cruising, and deceleration phases to enhance passenger comfort while mitigating mechanical wear. The system is particularly well-suited for high-speed and high-rise applications, supporting speeds up to 1,400 feet per minute, while maintaining smooth transitions between motion phases.

At the core of the invention is a centralized controller, which processes real-time sensor inputs and executes a sophisticated motion planning routine. This controller governs key system components, including a motor room board, a car panel controller, and multiple hall panel controllers, all of which communicate via a high-speed RS-485 serial communication network. This architecture ensures precise execution of speed commands at intervals of approximately 10 milliseconds, allowing for seamless acceleration and deceleration adjustments throughout a trip.

An important feature of the invention is its multi-profile speed management system, which allows the elevator to operate in distinct modes based on real-time conditions. The normal profile is used under standard operating conditions, prioritizing efficiency while ensuring smooth transitions between acceleration, cruising, and deceleration phases. The short-distance profile is optimized for low-floor travel, eliminating unnecessary cruising time by transitioning rapidly from acceleration to deceleration, thereby reducing overall trip duration. The emergency power profile activates during power failures, limiting speed and acceleration to conserve backup power and extend operational capability. The inspection profile is utilized for maintenance and diagnostic procedures, imposing strict speed limits and ensuring controlled movement to facilitate technician safety.

The system dynamically calculates and modifies the S-curve trajectory in real-time based on trip distance and active profile constraints. Unlike traditional elevator controllers, which rely on fixed acceleration and deceleration values, the present invention employs a real-time adaptive speed calculation routine. This allows for mid-flight destination changes, whereby a newly requested stop can be accommodated without abrupt speed shifts, provided that the recalculated speed remains within predefined safety parameters.

To further enhance efficiency, the system incorporates a stop rejection mechanism that prevents unnecessary or unsafe stops. If a newly requested stop is too close to the current position, the system rejects the request to prevent abrupt deceleration and jerky movement. Similarly, if accommodating a new stop would require increasing speed beyond the originally planned trajectory, the system rejects the request to avoid excessive acceleration, which could compromise ride quality, increase mechanical wear, and waste energy. This intelligent filtering ensures that only feasible stops are executed, improving overall operational efficiency.

A key advantage over prior art is the intelligent cruise speed adjustment mechanism, which dynamically recalculates the maximum feasible speed before each trip. Traditional systems rely on pre-programmed maximum speeds that do not account for real-time conditions, leading to inefficient travel times or unnecessary braking. The present system iteratively refines Vₘₐₓ based on available trip distance and active speed constraints, ensuring optimal efficiency while preventing unsafe motion transitions.

Another novel aspect is the precision floor leveling algorithm, which ensures that the elevator reaches its final stop position with near-zero deviation. While conventional systems may experience floor alignment errors due to delayed braking responses, the present system employs absolute position markers and high-frequency velocity feedback to achieve precise alignment. This eliminates the need for post-stop corrections, improving passenger safety and accessibility.

The invention further addresses mechanical longevity through its optimized jerk management strategy, which reduces high-frequency oscillations that lead to premature component degradation. By continuously modulating jerk-in and jerk-out values during acceleration and deceleration, the system minimizes stress on key mechanical elements such as the traction sheave, motor, and brake assembly.

In contrast to prior art control systems, which often operate with static motion planning and limited real-time adaptability, the present invention introduces a fully integrated, real-time dynamic motion control framework. This ensures not only smoother, more predictable rides but also enhanced energy efficiency, reduced mechanical wear, and improved system reliability.

Through the combination of adaptive motion profiling, intelligent speed adjustment, mid-flight stop optimization, precision leveling, and predictive jerk management, the present invention represents a significant advancement in traction elevator technology. It provides an unparalleled balance of speed, efficiency, and comfort, making it particularly advantageous for high-rise buildings, commercial complexes, and energy-conscious urban environments where reliability and performance are paramount.

### BRIEF DESCRIPTION OF THE DRAWINGS

In the detailed description of the preferred embodiments presented below, reference is made to the accompanying drawings.

FIG. 1 is a schematic illustration of a preferred traction elevator system.

FIG. 2 is an architecture drawing of a preferred traction elevator control system.

FIG. 3A is an exemplary graph of elevator car position versus time.

FIG. 3B is an exemplary graph of elevator car velocity versus time.

FIG. 3C is an exemplary graph of elevator car acceleration versus time.

FIG. 3D is an exemplary graph of elevator jerk versus time

FIG. 4 is a flow chart of a control routine for a preferred system.

FIG. 5 is a flow chart of an automatic operation routine for a preferred system.

FIG. 6A is a flow chart of a calculate maximum possible speed of run distance routine for a preferred system.

FIG. 6B is a flow chart of a S-curve calculation routine for a preferred system.

FIGS. 7A, 7B and 7C is a flow chart of an acceleration phase routine for a preferred system.

FIGS. 8A, 8B and 8C is a flow chart of a cruising phase routine for a preferred system.

FIGS. 9A, 9B and 9C is a flow chart of a deceleration phase routine for a preferred system.

FIG. 10 is a flow chart of an emergency power acceleration routine for a preferred system.

FIGS. 11A and 11B is a flow chart of an emergency power deceleration routine for a preferred system.

FIGS. 12A and 12B is a flow chart of an inspection acceleration routine for a preferred system.

FIG. 13 is a flow chart of an inspection cruising deceleration routine for a preferred system.

### DETAILED DESCRIPTION OF THE INVENTION

In the description that follows, like parts are marked throughout the specification and figures for the same numerals. The figures are not necessarily drawn to scale and may be shown in exaggerated or generalized form in the interest of clarity and conciseness. Unless otherwise noted, all tolerances and uses of the term “about” indicate plus or minus 20%.

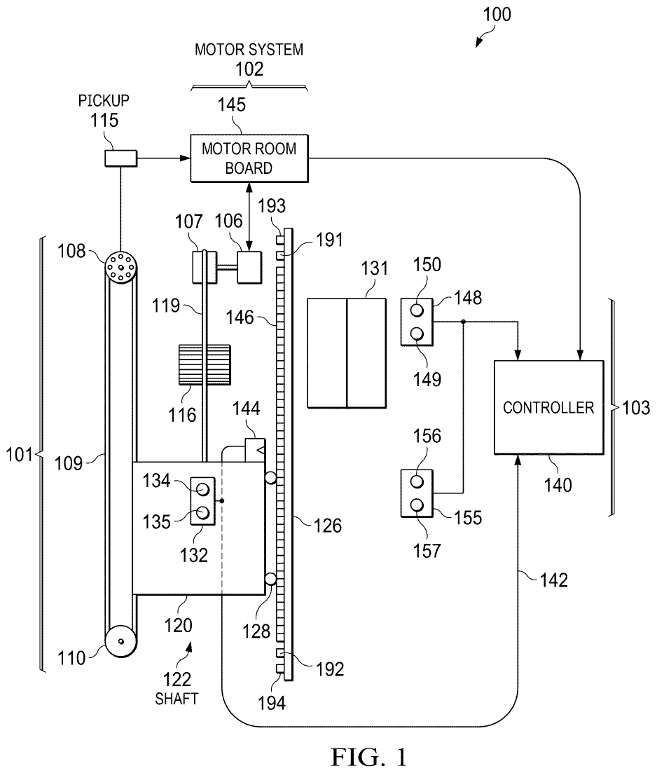

Referring to FIG. 1, preferred traction elevator system 100 will be further described.

Elevator system 100 includes mechanical system 101, motor system 102 and control system 103.

Mechanical system 101 includes elevator car 120 movably disposed within shaft 122. Shaft 122 is made up of a plurality of rails, such as rail 126. Elevator car 120 is guided up and down shaft 122, along rails 126 by a plurality of guide wheels, such as guide wheels 128. Mechanical doors, such as doors 131 are positioned adjacent shaft 122 at each floor level.

Motor system 102 includes drive motor 106, may either be a geared traction motor or a gearless traction motor. The drive motor 106 can also be either a DC or AC current motor. Drive motor 106 is mechanically coupled to traction sheave 107 mounted on the shaft of drive motor 106. Elevator car 120 is supported by hoist rope 119 which is reaved over traction sheave 107. Counterweight 116 is connected to hoist rope 119. Counterweight 116 offsets the weight of elevator car 120 and approximately half of its rated load and provides mechanical efficiency and operating smoothness to the system. When drive motor 106 is activated, it rotates traction sheave 107 thereby moving hoist rope 119, elevator car 120 and counterweight 116.

Governor rope 109 is also connected to elevator car 120 and is reaved over governor sheave 108, located at the highest point of travel of the car in shaft 122. Governor rope 109 is also reaved over pulley 110, located at the bottom of the elevator shaft. Pickup 115 is operably disposed adjacent governor sheave 108 to detect movement of the governor sheave, and hence elevator car 120 through optical or magnetic means, as is known in the art.

Control system 103 includes controller 140, car panel controller 132, control panels 148 and 155, sensor 144, motor room board 145, and pickup 115.

Controller 140 functions to receive command signals from the keypad, car panel controller and control panels and data from the various sensors and markers and then to calculate motor commands based on profiles stored in memory, as will be further described.

Car panel controller 132 includes control buttons 134 and 135 and circuitry used to open and close the car doors. Control buttons 134 and 135 are used to instruct the car as to the destination and direction of travel. Car panel controller 132 is operatively connected to controller 140 through umbilical cord 142.

Control panels 148 and 155 are fixed externally to shaft 122. Control panel 148 includes up button 150 and down button 149. Likewise control panel 155 includes up button 156 and down button 157. Both control panel 148 and control panel 155 are operatively connected to controller 140. The control panels send “call” signals to the controller, as will be further described.

Sensor 144 is operatively connected to car panel controller 132, adjacent tape 146. Preferably, the sensor is an optical sensor. Tape 146 is originally fixed longitudinally inside shaft 122 and includes a printed code or gradations that indicate vertical position in the shaft. In use, sensor 144 records elevator velocity and position by constantly examining tape 146, and sending data back to controller 140, as is known in the art. Sensor 144 is also capable of recording near terminal markers 191 and 192, and terminal markers 193 and 194. The near terminal markers and terminal markers are placed in specific locations in the elevator shaft as absolute reference points to signal certain critical areas. The near terminal markers and terminal markers may also be hard triggers such as magnetic switches hard wired to the motor room control board.

Motor room board 145 is operatively connected to controller 140. The motor room board acts as an interface to the controller and is responsible for the exchange of serial data between pickup 115 and drive motor 106 and generally managing communication and control signals throughout the system.

In operation, a passenger request signal for moving elevator car 120 in the up or down directions, to a specific destination, is received at car panel controller 132 or control panels 148 or 155. The request signal is sent to controller 140. Upon receipt of the signal, controller 140 conducts a number of calculations, and generates the appropriate signals to the motor room board, which activates the motor to control movement of elevator car 120, as will be further described.

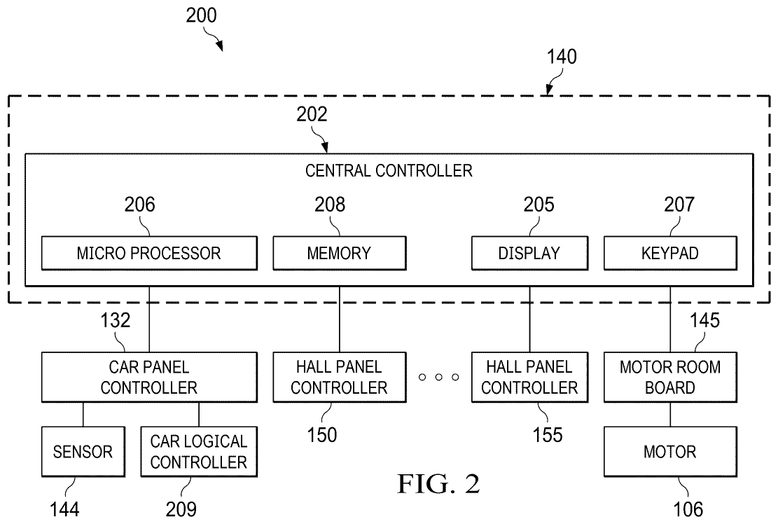

Referring to FIG. 2, a schematic overview of control system 200 will be further described.

Controller 140 includes microprocessor 206 operatively connected to memory 208. Memory 208 includes instructions, that when executed by microprocessor 206 cause the system to function, as will be further described. The controller further includes display 205 and keypad 207, both operatively connected to the microprocessor. The keypad is used to provide instructions and data to the microprocessor. The display is used for the microprocessor to indicate the current status of the system and show the values of various operational parameters of the system. Preferably, controller 140 is the MR Board Model No. SR3032, available from Smartrise Engineering, Inc. of Irving, Texas.

Controller 140 is operatively connected to motor room board 145. Motor room board 145 is further operatively connected to drive motor 106. Motor room board 145 functions as the primary interface to the controller responsible for the exchange of serial data between the motor, brakes, safety equipment, the hall panel controllers and the car panel controller. It plays a pivotal role in managing communication and control signals throughout the system. The motor room board also includes various settings that configure functionalities such as CPU stop, learn mode, and motor tune processes, ensuring safety checks are completed before enabling the motor contactor.

Motor room board 145 receives command signals from controller 140 and is responsible for activating and deactivating drive motor 106 which results in raising and lowering elevator car 120. Preferably, motor room board 145 is the Smartrise Universal Board Model No. SR 3030, available from Smartrise Engineering, Inc. of Irving, Texas.

Controller 140 is further operatively connected to a number of hall panel controllers, such as hall control panels 148 and 155. In one embodiment, controller 140 supports up to 32 hall control panels. The hall control panels receive signals from hall call buttons and transmits them directly to the central controller, as will be further described. Preferably, the hall panel controllers are each a hall board Model No. SR 1060, available from Smartrise Engineering, Inc.

Controller 140 is further connected to car panel controller 132. Car panel controller 132 receives signals from call buttons and other safety mechanisms and passes them directly to controller 140. Car panel controller 132 is operatively connected to sensor 144. The car panel controller receives signals from sensor 144 related to the car's position and velocity, and passes them directly to controller 140, as will be further described.

Car panel controller 132 is further connected to car logic controller 209. Car logic controller 209 generates and sends control signals which regulate opening and closing the car doors (not shown). Car logic controller 209 is preferably the CLC Board available from Smartrise Engineering, Inc. of Irving, Texas.

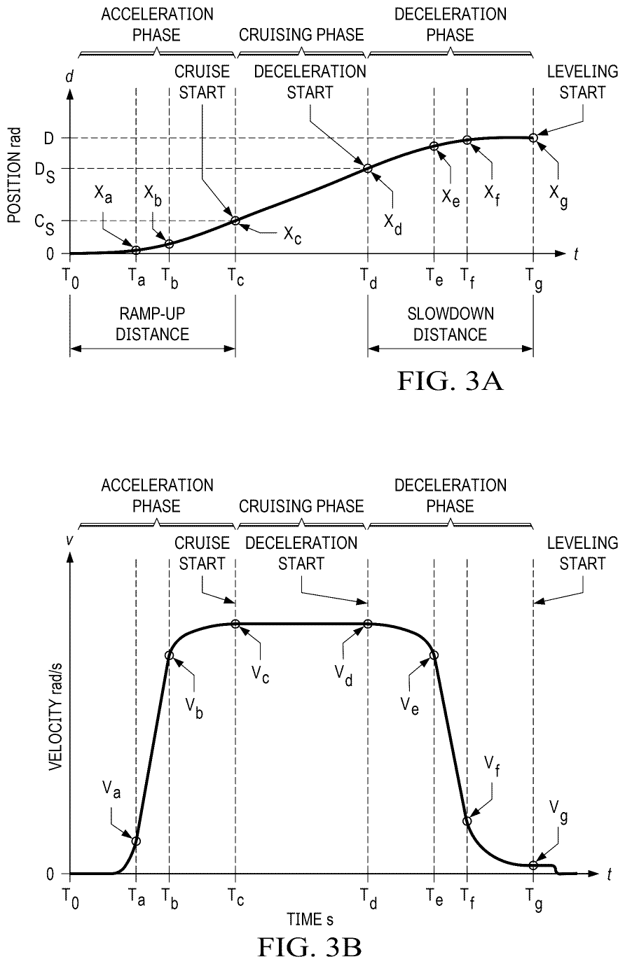

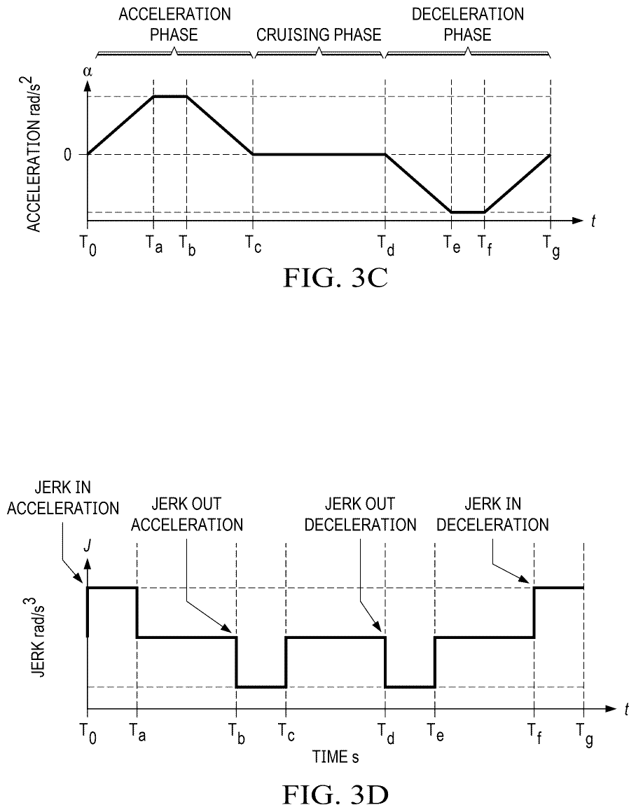

Referring to FIGS. 3A, 3B, 3C and 3D, relevant motion curves will be further described. Each curve is divided into three phases. The first phase is the acceleration phase, during which the speed escalates from zero to the cruising (or maximum) speed. The second phase, the cruising phase, maintains a constant speed with zero acceleration. The third phase is the deceleration phase during which the speed decreases from the cruising speed to zero, after a leveling period.

The phases may be demarcated by a series of time inflection points, T, velocity inflection points, V, and position inflection points, X. At T₀, the car is at rest and the start velocity, V₀, is zero. The position, Xₐ, is the start position. At time, Tₐ, the elevator car has reached velocity, Vₐ, and has traveled a distance, Xₐ. This is also the point where constant acceleration begins. When constant acceleration stops, the elevator car has reached velocity, V_{b} and has traveled a distance, X_{b}, at time, T_{b}. The elevator car stops accelerating at time, T_{c}, at which it has traveled a distance, X_{c}, and velocity, V_{c}. This is also known as the ramp up distance. At time, Tₐ, the elevator ends its cruising phase and begins decelerating at velocity, V_{d}, and has traveled a distance, X_{d}. In a preferred embodiment, the velocity, V_{c}, and V_{d}, are equal.

At time, Tₑ, the elevator car begins constant deceleration and has traveled a distance, Xₑ, and at velocity, Vₑ. At time, T_{f}, the elevator car ends constant deceleration and has traveled a distance, X_{f}, and velocity, V_{f}. The elevator car begins leveling and has traveled a distance, X_{g}, at time, T_{g}, and at velocity, V_{g}.

For acceleration, the first phase involves a constant positive jerk, resulting in a linear increase in acceleration and hence a parabolic growth in velocity. When acceleration is constant and jerk is zero, speed increases linearly until jerk takes on a constant negative value. This results in a linear decrease in acceleration and, consequently, a parabolic decay in velocity. The dynamics of the deceleration phase mirror those of the acceleration phase, though jerk and acceleration values can vary significantly between phases.

Although the deceleration curve is generally symmetric in shape to the acceleration curve, S-curve, the speed during deceleration is reduced to a minimum value which is referred to as the “leveling speed.” The elevator moves at that speed before eventually stopping when it reaches the destination position. The leveling speed and the distance at which the leveling speed is commanded (known as the “leveling distance”) are both predefined and adjustable parameters.

In operation, the elevator car accelerates from zero velocity to a constant high speed over an acceleration time. The car maintains this constant high speed for a finite time, until it reaches the slow-down position or “transition position.” The constant high speed should always be below the maximum speed of the elevator set during installation known as the “contract speed.” Upon reaching the transition position, the elevator car begins to decelerate from the constant high speed, through the deceleration time, toward the constant leveling speed. The elevator car moves through a transition distance when its velocity is between the constant high speed and the constant leveling speed during the transition time. After the transition distance, the elevator car reaches a constant leveling speed, and stays at this constant leveling speed, throughout the leveling distance, during the leveling time. After the leveling time, the car comes to a complete stop at the destination. The transition distance plus the leveling distance is known as the “slowdown distance.”

The cruising start position, the deceleration start position, and the leveling start position are all relative terms that depend on the start position of the elevator car and the direction of travel. For example, if the elevator car is at elevation zero, the ground floor, then the cruise start position is equal to the ramp up distance. However, if the elevator is at a different start position, then the cruising start position, if the elevator car is moving up, is equal to the actual start position plus the ramp up distance and, if the elevator car is moving down, then the cruising start position is equal to the actual start position minus the ramp up distance.

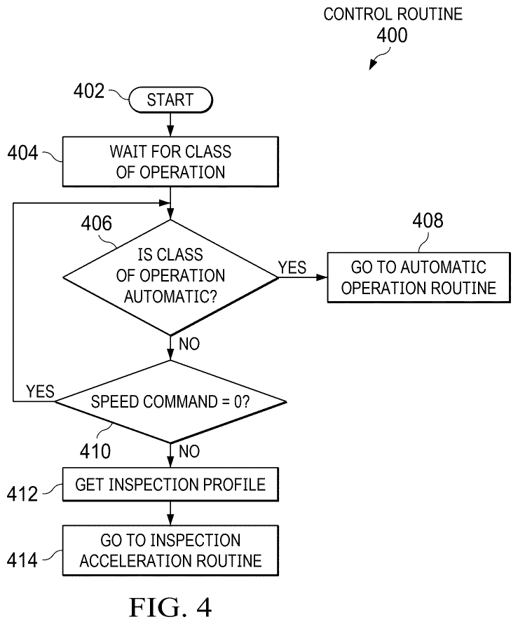

Referring then to FIGS. 4-13, methods of system operation will be further described. Preferably, the methods are achieved through software, resident in memory 208, which controls the operation of microprocessor 206. In general, the methods monitor the operation of the elevator during each run and collect data from the sensors which is used to adjust the instantaneous speed command based on one of four profiles. Each profile preferably includes a list of parameters as follows:

Contract Speed: This is the maximum speed possible and is used along with the other S-curve adjustment parameters to compute the cruising speed of each run.

Acceleration: Defines the maximum acceleration rate during the acceleration phase.

Jerk-In Acceleration: Sets the positive jerk rate (rate of acceleration increase) during the acceleration phase.

Jerk-Out Acceleration: Establishes the negative jerk rate (rate of acceleration decrease) during the acceleration phase.

Deceleration: Determines the maximum deceleration rate during the deceleration phase.

Jerk-In Deceleration: Assigns the negative jerk rate (rate of acceleration decrease) during the deceleration phase.

Jerk-Out Deceleration: Sets the positive jerk rate (rate of acceleration increase) during the deceleration phase.

Leveling Speed: This is the final speed of the elevator at the end of the S-curve before reaching the destination position.

Leveling Distance: Specifies the distance from the destination at which the car transitions to the leveling speed.

Referring then to FIG. 4, control routine 400 will be further described.

At step 402, the method begins.

At step 404, central controller 202 waits for an input from the keypad as to the class of operation. In a preferred embodiment, the class of operation can either be “automatic” or “inspection.” Once the input is received, the method moves to step 406.

At step 406, the microprocessor decides whether or not the class of operation is “automatic.” If so, the method moves to 408. If not, the method moves to step 410.

At step 408, the microprocessor moves to the automatic operation routine, as will be further described.

At step 410, the microprocessor decides whether or not a speed command has been entered on the keypad that is equal to zero. If so, the method returns to step 406. If not, the method moves to step 412.

At step 412, the microprocessor retrieves the inspection profile from memory.

In a preferred embodiment, the inspection profile comprises the following values.

| “Up” Parameter Set | “Down” Parameter Set |
|---|---|
| Jᵢₐ (Jerk-In Acceleration) = | Jᵢₐ (Jerk-In Acceleration) = |
| 1.5 f/s\hat{ }3 | 1.5 f/s\hat{ }3 |
| J₀ₐ (Jerk-Out Acceleration) = | J₀ₐ (Jerk-Out Acceleration) = |
| 1.5 f/s\hat{ }3 | 1.5 f/s\hat{ }3 |
| A (Acceleration) = 1 f/s\hat{ }2 | A (Acceleration) = 1 f/s\hat{ }2 |
| V_{c} (Contract Speed) = 300 fpm | V_{c} (Contract Speed) = 300 fpm |
| J_{id} (Jerk-In Deceleration) = 2 f/s\hat{ }3 | J_{id} (Jerk-In Deceleration) = 2 f/s\hat{ }3 |
| J_{od} (Jerk-Out Deceleration) = | J_{od} (Jerk-Out Deceleration) = |
| 0.8 f/s\hat{ }3 | 0.8 f/s\hat{ }3 |
| D (Deceleration) = 1 f/s\hat{ }2 | D (Deceleration) = 1 f/s\hat{ }2 |
| D_{L} (Leveling Distance) = 1 in | D_{L} (Leveling Distance) = 1 in |
| Vᵢ (Leveling Speed) = 10 fpm | Vᵢ (Leveling Speed) = 10 fpm |
| Inspection Speed = 50 fpm | Inspection Speed = 50 fpm |

At step 414, the method moves to the inspection acceleration routine, as will be further described.

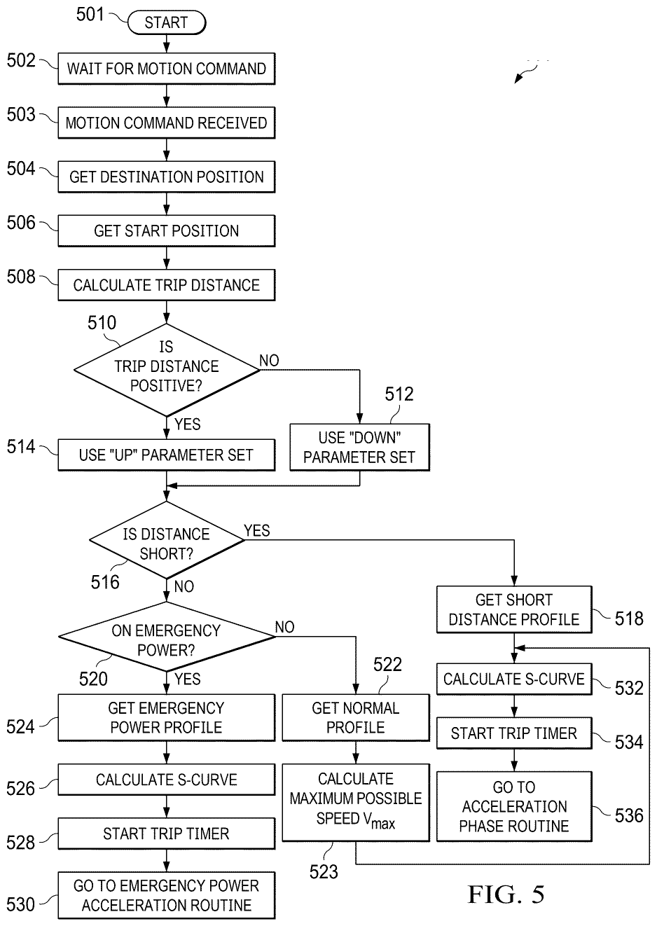

Referring to FIG. 5, automatic operation routine 500 will be further described.

In general, FIG. 5 illustrates the automatic operation routine of the traction elevator control system, designed to guide the elevator car from a starting position to a specified destination using advanced S-curve motion profiles. The routine begins by waiting for a motion command, which is typically received from either a car control panel or a hall panel controller. Upon receiving the command, the system calculates the trip distance by determining the difference between the starting and destination positions. Based on the trip distance, the system selects one of three operational profiles: the “normal” profile for standard distances, the “short distance” profile for shorter trips, or the “emergency power” profile if the system is running on backup power. The controller then computes the maximum possible speed for the trip, ensuring efficient travel while maintaining passenger comfort and safety. Once the S-curve is calculated, the trip timer is started, and the system transitions into the acceleration routine, initiating smooth and controlled movement toward the destination while continuously monitoring speed and position.

At step 501, the method begins.

At step 502, the microprocessor waits for a motion command, typically received from a car control or a hall panel controller.

At step 503, a motion command is received, including a destination position.

At step 504, the microprocessor retrieves the destination position from the motion command.

At step 506, the microprocessor retrieves the car start position from either sensor 144 or pickup 115.

At step 508, the microprocessor calculates the trip distance by subtracting the start position from the destination position.

At step 510, the microprocessor decides whether or not the trip distance value is positive. If not, the method moves to step 512. If so, the method moves to step 514.

At step 512, the microprocessor sets a flag indicating use of the “down” parameter set from the profile.

At step 514, the microprocessor sets a flag indicating that the “up” parameter set from the profile is to be used.

At step 516, the microprocessor decides whether or not the trip distance is considered “short.” In a preferred embodiment, the trip distance is considered short if it is less than five floors (e.g. fewer than five floors or less than the required distance to reach cruising speed). However, in other embodiments, the trip distance may be considered short if it is any number of floors less than that required to reach the cruise start position, as will be further described. If the distance is considered short, the method moves to step 518. If not, the method moves to step 520.

At step 518, the microprocessor retrieves the “short distance” profile from memory. In a preferred embodiment, the short distance profile is as follows.

| “Up” Parameter Set | “Down” Parameter Set |
|---|---|
| Jᵢₐ (Jerk-In Acceleration) = | Jᵢₐ (Jerk-In Acceleration) = |
| 2 f/s\hat{ }3 | 2 f/s\hat{ }3 |
| J₀ₐ (Jerk-Out Acceleration) = | J₀ₐ (Jerk-Out Acceleration) = |
| 4 f/s\hat{ }3 | 4 f/s\hat{ }3 |
| A (Acceleration) = 3 f/s\hat{ }2 | A (Acceleration) = 3 f/s\hat{ }2 |
| V_{c} (Contract Speed) = 300 fpm | V_{c} (Contract Speed) = 300 fpm |
| J_{id} (Jerk-In Deceleration) = 2 f/s\hat{ }3 | J_{id} (Jerk-In Deceleration) = 2 f/s\hat{ }3 |
| J_{od} (Jerk-Out Deceleration) = | J_{od} (Jerk-Out Deceleration) = |
| 4 f/s\hat{ }3 | 4 f/s\hat{ }3 |
| D (Deceleration) = 3 f/s\hat{ }2 | D (Deceleration) = 3 f/s\hat{ }2 |
| D_{L} (Leveling Distance) = 1 in | D_{L} (Leveling Distance) = 1 in |
| Vᵢ (Leveling Speed) = 10 fpm | Vᵢ (Leveling Speed) = 10 fpm |

At step 532, the microprocessor calculates the initial S-curve, as will be further described.

At step 534, the microprocessor starts a trip timer, as will be further described.

At step 536, the method proceeds to the acceleration phase routine, as will be further described.

At step 520, the microprocessor decides whether or not the system is running on “emergency power.” In the preferred embodiment, the microprocessor receives a message from one or more of the car panel controller, the hall panel controllers, or the motor room board, indicating that a power failure has occurred, or that generator or battery backup power has been activated. Such a message sets a flag in memory that is interpreted by the microprocessor at this step.

If so, the method moves to step 524. If not, the method moves to step 522.

At step 522, the microprocessor retrieves the “normal” profile from memory and moves to step 523. In a preferred embodiment, the normal profile is as follows.

| “Up” Parameter Set | “Down” Parameter Set |
|---|---|
| Jᵢₐ (Jerk-In Acceleration) = | Jᵢₐ (Jerk-In Acceleration) = |
| 2 f/s\hat{ }3 | 2 f/s\hat{ }3 |
| J₀ₐ (Jerk-Out Acceleration) = | J₀ₐ (Jerk-Out Acceleration) = |
| 2 f/s\hat{ }3 | 2 f/s\hat{ }3 |
| A (Acceleration) = 2 f/s\hat{ }2 | A (Acceleration) = 2 f/s\hat{ }2 |
| V_{c} (Contract Speed) = 300 fpm | V_{c} (Contract Speed) = 300 fpm |
| J_{id} (Jerk-In Deceleration) = 2 f/s\hat{ }3 | J_{id} (Jerk-In Deceleration) = 2 f/s\hat{ }3 |
| J_{od} (Jerk-Out Deceleration) = | J_{od} (Jerk-Out Deceleration) = |
| 0.8 f/s\hat{ }3 | 0.8 f/s\hat{ }3 |
| D (Deceleration) = 1 f/s\hat{ }2 | D (Deceleration) = 1 f/s\hat{ }2 |
| D_{L} (Leveling Distance) = 1 in | D_{L} (Leveling Distance) = 1 in |
| Vᵢ (Leveling Speed) = 10 fpm | Vᵢ (Leveling Speed) = 10 fpm |

At step 523, the microprocessor calculates the maximum possible speed for the run distance, Vₘₐₓ, as will be further described, and moves to step 532.

At step 524, the microprocessor retrieves the “emergency power” profile from memory. In a preferred embodiment, the emergency power profile is as follows.

| “Up” Parameter Set | “Down” Parameter Set |
|---|---|
| Jᵢₐ (Jerk-In Acceleration) = | Jᵢₐ (Jerk-In Acceleration) = |
| 1.8 f/s\hat{ }3 | 1.8 f/s\hat{ }3 |
| J₀ₐ (Jerk-Out Acceleration) = | J₀ₐ (Jerk-Out Acceleration) = |
| 1.8 f/s\hat{ }3 | 1.8 f/s\hat{ }3 |
| A (Acceleration) = 1.5 f/s\hat{ }2 | A (Acceleration) = 1.5 f/s\hat{ }2 |
| E-power Speed = 100 fpm | E-power Speed = 100 fpm |
| J_{id} (Jerk-In Deceleration) = | J_{id} (Jerk-In Deceleration) = |
| 1.8 f/s\hat{ }3 | 1.8 f/s\hat{ }3 |
| J_{od} (Jerk-Out Deceleration) = | J_{od} (Jerk-Out Deceleration) = |
| 1.8 f/s\hat{ }3 | 1.8 f/s\hat{ }3 |
| D (Deceleration) = 1.5 f/s\hat{ }2 | D (Deceleration) = 1.5 f/s\hat{ }2 |
| D_{L} (Leveling Distance) = 1 in | D_{L} (Leveling Distance) = 1 in |
| Vᵢ (Leveling Speed) = 10 fpm | Vᵢ (Leveling Speed) = 10 fpm |

At step 526, the microprocessor calculates the initial S-curve, as will be further described.

At step 528, the microprocessor starts the trip timer.

At step 530, the microprocessor moves to the emergency power acceleration routine, as will be further described.

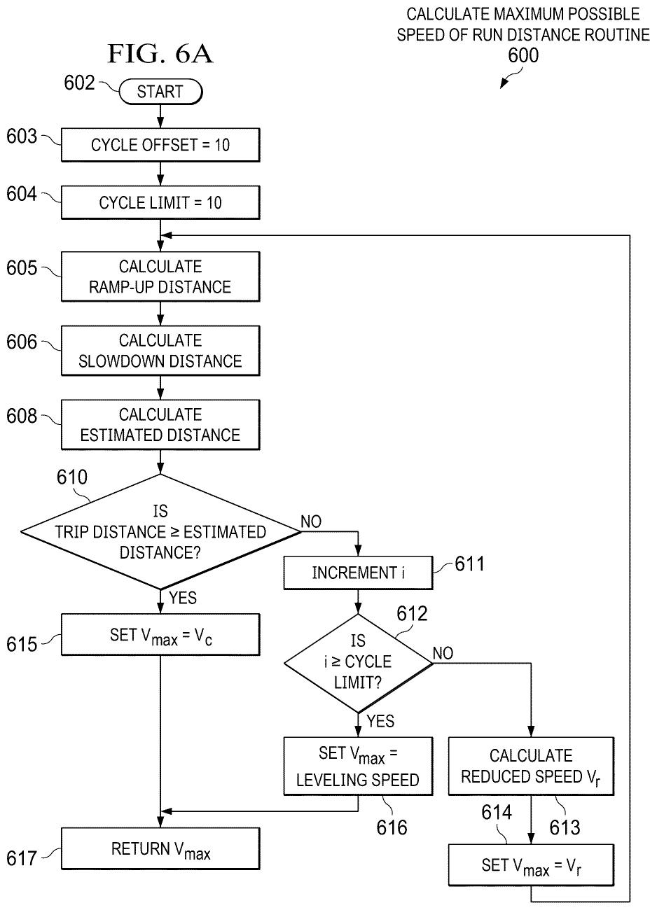

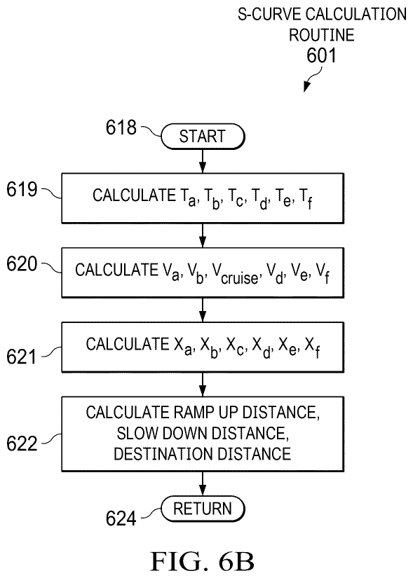

Referring to FIG. 6A, calculate maximum possible speed of run distance routine 600 will be further described. Before each elevator run, the control system calculates the highest feasible speed based on the available trip distance. In general, routine 600 begins by estimating the ramp-up and slowdown distances needed for smooth acceleration and deceleration. If the total required distance is within the available space, the maximum speed is set to the contract speed, V_{c}. If not, the system iteratively reduces the speed until a feasible value is found. This ensures efficient travel while preventing overshooting or abrupt stops. A series of iterations is conducted to find an estimated distance less than or equal to the new requested destination and reduce maximum speed accordingly. If no valid speed is determined within the iteration limit, the system defaults to a safe leveling speed.

At step 602, the method begins.

At step 603, the microprocessor sets a variable “cycle limit” to 10. This variable may assume other values.

At step 604, the microprocessor sets a counter variable “i” to 10. This variable may assume other values.

At step 605, the microprocessor calculates the ramp up distance, as will be further described.

At step 606, the microprocessor calculates the slowdown distance, as will be further described.

At step 608, the microprocessor calculates the estimated distance by adding the ramp up distance to the slowdown distance according to the following equation.

Estimated distance=ramp up distance+slowdown distance

At step 610, the microprocessor decides whether or not the trip distance, calculated at step 508, is greater than or equal to the estimated distance. If not, the method moves to step 611. If so, the method moves to step 615.

At step 615, the microprocessor sets the maximum speed, Vₘₐₓ equal to the contract speed, Vₛ and moves to step 617.

At step 611, the microprocessor increments the cycle counter “i” by 1.

At step 612, the microprocessor determines whether the cycle counter “i” has met or exceeded the cycle limit. If so, the method moves to step 616. If not, the method moves to step 613.

At step 613, the microprocessor calculates the value of the reduced speed “Vᵣ” by use of the following equation:

$${V}_{r} = {V}_{c} \times ( 1 - ( i \times cycle limit ) )$$

Where:
Vᵣ=reduced speed;
V_{c}=contract speed; and
i=counter variable.

At step 614, the microprocessor sets the maximum speed, Vₘₐₓ, equal to the reduced speed, Vᵣ. The method then returns to step 605.

At step 616, the microprocessor sets the maximum speed, Vₘₐₓ, equal to the leveling speed, Vᵢ, and moves to step 617.

At step 617, the microprocessor returns the value Vₘₐₓ.

Referring to FIG. 6B, method 601, the S-curve calculation routine, will be further described. In a preferred embodiment, this method calculates the time, velocity and position inflection points for an S-curve acceleration and deceleration profile, optimizing the smooth transition and precise control of elevator movements. The maximum speed, Vₘₐₓ, is at most the contact speed, V_{c}, but can be varied by other routines to Vᵣ, Vₘ, V_{sc}, V_{emergency}, V_{inspection}, V_{near terminal}, or V_{short floor}, which are reduced maximum speeds appropriate for different profiles, as will be further described.

At step 618, the method begins.

At step 619, the microprocessor calculates values for time inflection points Tₐ, T_{b}, T_{c}, Tₐ, Tₑ, and T_{f}, according to the following equations:

$${T}_{a} = \frac{A}{{J}_{i a}}$$

Where:
Tₐ=time at the beginning of constant acceleration;
A=acceleration; and
Jᵢₐ=jerk-in acceleration.

$${T}_{b} = \frac{{V}_{max}}{A} + 0.5 A ( \frac{1}{{J}_{i a}} - \frac{1}{{J}_{0 a}} )$$

Where:
T_{b}=time at the end of constant acceleration;
Vₘₐₓ=maximum possible cruising speed;
A=acceleration;
Jᵢₐ=jerk-in acceleration; and
J₀ₐ=jerk-out acceleration.

$${T}_{c} = \frac{{V}_{max}}{A} + 0.5 \times A ( \frac{1}{{J}_{i d}} - \frac{1}{{J}_{o d}} )$$

Where:
T_{c}=time at the beginning of cruising phase;
Vₘₐₓ=maximum possible cruising speed;
A=acceleration;
Jᵢₐ=jerk-in acceleration; and
J₀ₐ=jerk-out acceleration.

$${T}_{d} = \frac{( {V}_{max} - {V}_{i} )}{D} + 0.5 \times D ( \frac{1}{{J}_{i d}} + \frac{1}{{J}_{o d}} )$$

Where:
Tₐ=time at the end of cruising phase;
Vₘₐₓ=maximum possible cruising speed;
Vᵢ=leveling speed;
D=deceleration;
J_{id}=jerk-in deceleration; and
J_{od}=jerk-out deceleration.

$${T}_{e} = \frac{( {V}_{max} - {V}_{i} )}{D} + 0.5 \times D ( \frac{1}{{J}_{i d}} - \frac{1}{{J}_{o d}} )$$

Where:
Tₑ=time at the beginning of deceleration phase;
Vₘₐₓ=maximum possible cruising speed;
Vᵢ=leveling speed;
D=deceleration;
J_{id}=jerk-in deceleration; and
J_{od}=jerk-out deceleration.

$${T}_{f} = \frac{D}{{J}_{i d}}$$

Where:
T_{f}=time at the end of constant deceleration;
D=deceleration; and
J_{id}=jerk-in deceleration.

At step 620, the microprocessor calculates values for velocity inflection points Vₐ, V_{b}, V_{cruise}, V_{d}, Vₑ, V_{f}, according to the following equations:

$${V}_{a} = 0.5 \times {J}_{i a} \times ( {T}_{a}^{2} )$$

Where:
Vₐ=velocity at beginning of constant acceleration;
Jᵢₐ=jerk-in acceleration; and
Tₐ=time at the beginning of constant acceleration.

$${V}_{b} = A ( {T}_{b} - {T}_{a} ) + {V}_{a}$$

Where:
V_{b}=velocity at end of constant acceleration;
T_{b}=time at end of constant acceleration; and
A=acceleration.

$${V}_{cruise} = maximum possible cruising speed$$

$${V}_{d} = {V}_{cruise}$$

$${V}_{e} = D ( {T}_{e} - {T}_{f} ) + {V}_{f}$$

Where:
Vₑ=velocity at beginning of constant deceleration;
D=deceleration;
Tₑ=time at beginning of constant deceleration; and
V_{f}=velocity at end of constant deceleration.

$${V}_{f} = 0.5 \times {J}_{i d} \times ( {T}_{f}^{2} ) + {V}_{i}$$

Where:
V_{f}=velocity at end of constant deceleration;
J_{id}=jerk-in deceleration;
T_{f}=time at end of constant deceleration; and
Vᵢ=leveling speed.

At step 621, the microprocessor calculates values for position inflection points Xₐ, X_{b}, X_{c}, X_{d}, Xₑ, and X_{f}, according to the following equations:

$${x}_{a} = {J}_{i a} \times \frac{( {T}_{a}^{3} )}{6}$$

Where:
Xₐ=distance traveled at beginning of constant acceleration;
Jᵢₐ=jerk-in acceleration; and
Tₐ=elapsed time at beginning of constant acceleration.

$${X}_{b} = 0.5 A \times ( {T}_{b}^{2} ) + {V}_{a} \times ( {T}_{b} - {T}_{a} ) + {X}_{a}$$

Where:
X_{b}=distance traveled at end of constant acceleration;
A=acceleration;
T_{b}=elapsed time at end of constant acceleration;
Vₐ=velocity at beginning of constant acceleration; and
Tₐ=elapsed time at beginning of constant acceleration.

$${X}_{c} = 0.5 \times A \times ( {( {T}_{c} - {T}_{b} )}^{2} ) - {J}_{o a} \times \frac{( {( {T}_{c} - {T}_{b} )}^{3} )}{6} + {V}_{b} \times ( {T}_{c} - {T}_{b} ) + {X}_{b}$$

Where:
X_{c}=distance traveled at beginning of cruising phase;
A=acceleration;
T_{b}=elapsed time at end of constant acceleration;
V_{b}=velocity at end of constant acceleration;
T_{c}=elapsed time at beginning of cruising phase;
X_{b}=position at end of constant acceleration; and
Jₒₐ=jerk-out acceleration.

$${X}_{d} = 0.5 \times D \times ( {( {T}_{d} - {T}_{e} )}^{2} ) - {J}_{o d} \times \frac{( {( {T}_{d} - {T}_{e} )}^{3} )}{6} + {V}_{e} \times ( {T}_{d} - {T}_{e} ) + {X}_{e}$$

Where:
X_{d}=distance traveled at end of cruising phase;
D=deceleration;
Tₐ=elapsed time at end of cruising phase;
Tₑ=elapsed time at beginning of constant deceleration;
J_{od}=jerk-out deceleration;
Vₑ=velocity at beginning of constant deceleration; and
Xₑ=distance traveled at beginning of constant deceleration.

$${X}_{e} = 0.5 \times D \times {( {T}_{e} - {T}_{f} )}^{2} + {V}_{a} \times ( {T}_{e} - {T}_{f} ) + {X}_{f}$$

Where:
Xₑ=distance traveled at beginning of constant deceleration;
D=deceleration;
Tₑ=elapsed time at beginning of constant deceleration;
T_{f}=time at end of constant deceleration; and
X_{f}=distance traveled at end of constant deceleration.

$${x}_{f} = {J}_{i d} \times \frac{( {T}_{f}^{3} )}{6} + {V}_{i}$$

Where:
X_{f}=distance traveled at end of constant deceleration;
J_{id}=jerk-in deceleration;
T_{f}=time at end of constant deceleration; and
Vᵢ=leveling speed.

At step 622, the microprocessor calculates the ramp up distance, the slowdown distance and the destination distance as follows:

$$Ramp up distance = {X}_{c}$$

$$Slow down distance = {X}_{g} - {X}_{d}$$

$$Destination distance = {X}_{g} + {D}_{l}$$

Where:
Dₗ=leveling distance; and
X_{g}=leveling start distance.

At step 624, the method concludes and returns.

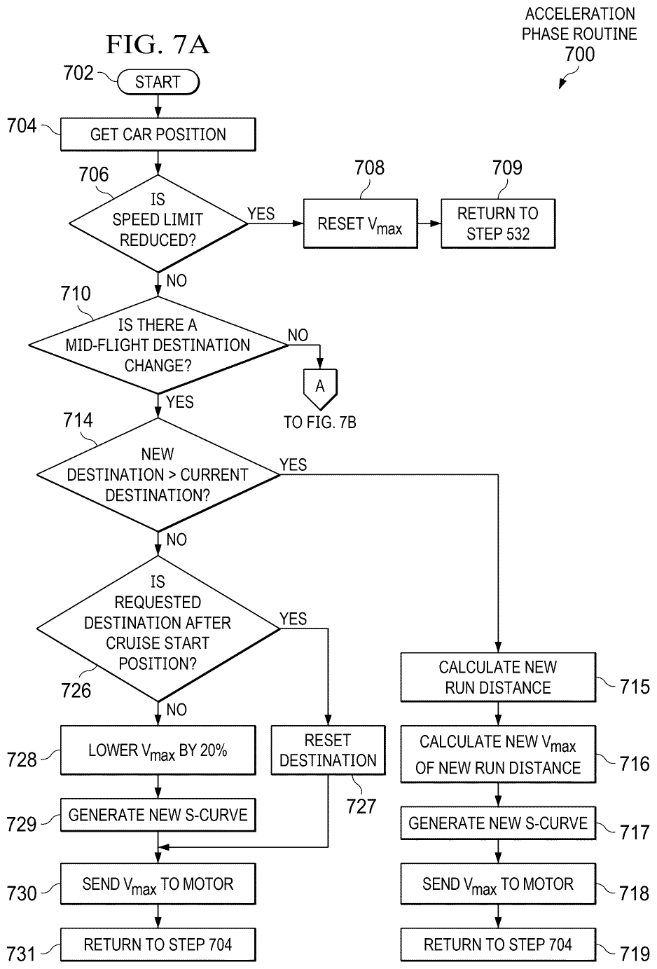

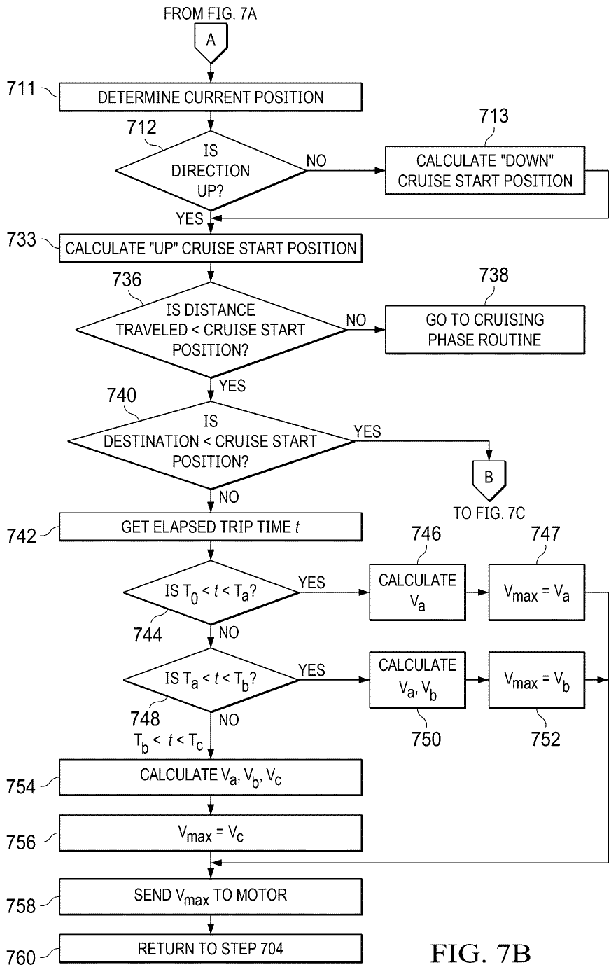

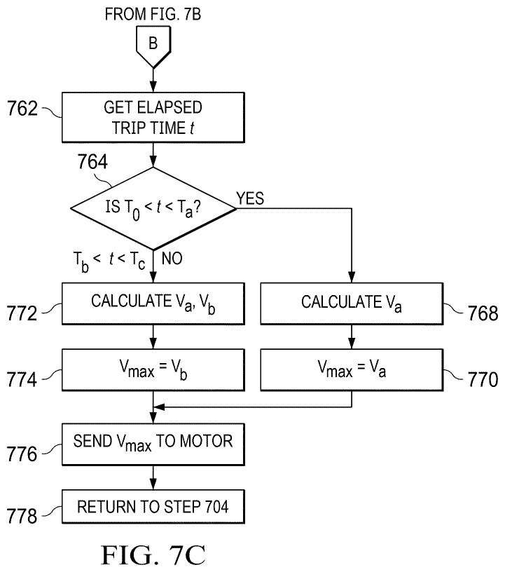

Referring then to FIGS. 7A, 7B and 7C, acceleration phase routine 700 will be further described. In a preferred embodiment, this routine controls motor speed during the acceleration phase, compensating for changes in destination and reduced speed limits using the initial S-curve and modifying it when necessary.

In general, FIGS. 7A, 7B, and 7C illustrate the acceleration phase routine of the traction elevator control system, which governs the elevator car's transition from a stationary state to its cruising speed using an optimized S-curve profile. The routine begins by determining the elevator car's current position and checking whether the maximum speed has been reduced due to system conditions. The system also evaluates if there has been a mid-flight destination change, recalculating the run distance and generating a new S-curve if necessary. During acceleration, the system monitors whether the elevator has reached the cruise start position, ensuring that acceleration is adjusted to maintain smooth motion. The routine then calculates the instantaneous velocity at different time intervals using predefined inflection points and sends corresponding speed commands to the motor. The process continues until the elevator reaches the cruise start position, at which point the system transitions to the cruising phase routine.

At step 702, the method begins.

At step 704, the microprocessor retrieves a value indicating the position of the elevator car by retrieving position data from sensor 144 or pickup 115.

At step 706, the microprocessor determines whether or not the maximum speed, Vₘₐₓ, has been reduced to a lower speed, such as Vᵣ, as previously described. If so, the method moves to step 708. If not, the method moves to step 710.

At step 708, if not already done so, the maximum speed, Vₘₐₓ, is then reset to the lower speed, e.g., Vₘ or Vᵢ.

At step 709, the method returns to step 532, as previously described.

At step 710, the microprocessor checks for signal from the car panel controller, the hall panel controllers or the controller keypad to determine whether or not a mid-flight destination change has been commanded. This feature allows the system to dynamically adjust the elevator's motion profile in real-time, ensuring that the elevator can efficiently respond to new passenger requests while in transit. If a destination change is detected, the system recalculates the run distance, adjusts the maximum possible speed, and regenerates the S-curve profile to provide a smooth transition to the updated destination. This process prevents abrupt stops or inefficient speed adjustments, maintaining passenger comfort and minimizing wear on mechanical components. This feature enhances the elevator's operational efficiency and responsiveness, which is particularly valuable in high-traffic environments where mid-flight destination changes are common. By dynamically adjusting the speed profile without compromising ride quality, the system reduces travel time, increases passenger throughput, and extends the lifespan of mechanical components due to smoother motion transitions. This real-time recalculation capability represents a significant improvement over traditional elevator control systems, which may be unable to adapt smoothly to mid-flight changes. As such, this feature contributes to the elevator system's enhanced efficiency, passenger comfort, and mechanical durability. If not, the method moves to step 711. If so, the method moves to step 714.

At step 714, the microprocessor determines whether or not the new destination is greater than the current destination in memory. In a preferred embodiment, the absolute value of the difference is used so as to compensate for the elevator car direction, up or down. If so, the microprocessor moves to step 715. If not, the microprocessor moves to step 726.

At step 715, the microprocessor calculates a new run distance according to the following equation:

New run distance=(new destination-cruising start position)

At step 716, the microprocessor calculates the new maximum possible speed of the new run distance, as previously described. In a preferred embodiment, the step is carried out by repeating run distance routine 600.

At step 717, the microprocessor regenerates a new S-curve, using the new value of Vₘₐₓ, as previously described. In a preferred embodiment, this step is accomplished by repeating method 601.

At step 718, the microprocessor sends the value of Vₘₐₓ to the motor.

At step 719, the microprocessor then returns to step 704.

At step 726, the microprocessor determines whether or not the elevator car will arrive at the new requested destination before or after the cruise start position. If so, the method moves to step 727. If not, the method moves to step 728.

At step 727, the microprocessor resets the destination position to the new destination, and moves to step 730.

At step 728, the microprocessor lowers the maximum speed value, Vₘₐₓ, by 20%, and moves to step 729.

At step 729, the microprocessor regenerates a new S-curve, using the new value of Vₘₐₓ, as previously described, and moves to step 730. In a preferred embodiment, this step is accomplished by method 601.

At step 730, the microprocessor sends the new value of Vₘₐₓ, to the motor. At step 731, the microprocessor returns to step 704.

Continuing with FIG. 7B, at step 711, assuming that there is no midflight destination change, microprocessor determines the current position of the elevator car. In a preferred embodiment, the current position is simply read from the sensors. In another embodiment, a running log of total upward movement minus total downward movement is kept by the microprocessor and stored in memory to indicate current position

At step 712, the microprocessor checks a flag to determine whether or not the direction of travel is up. If not, the method moves to step 713. If so, the method moves to step 733. In the control system, the up preset flag and down preset flag are set based on the relative position of the elevator car and the requested destination. When a new destination is entered, the control system compares the current position of the elevator with the target position. If the target floor is above the current position, the up preset flag is set to indicate upward travel. Conversely, if the target floor is below the current position, the down preset flag is set to indicate downward travel. These flags help the system determine the direction of motion and ensure that the appropriate acceleration, cruising, and deceleration profiles are selected. The flags are updated dynamically in real-time whenever a new destination is requested or when the system recalculates the travel profile due to a mid-flight destination change, ensuring accurate and efficient travel direction control.

At step 733, the microprocessor calculates the “up” cruising start position according to the following equation.

Cruising start position=start position+ramp up distance

The method then moves to step 736.

At step 713, the microprocessor calculates the “down” cruise start position according to the following equation.

Cruising start position=start position−ramp up distance

The method then moves to step 736.

At step 736, the microprocessor determines whether or not the current position is less than the cruise start position, using the absolute value. If not, the processor moves to step 738. If so, the processor moves to step 740.

At step 738, the microprocessor moves to the cruising phase routine, as will be further described.

At step 740, the microprocessor determines whether or not the destination position is less than the cruise start position. If not, the moves to step 742. If so, the microprocessor moves to step 762.

At step 742, the microprocessor retrieves the elapsed trip time from memory.

At step 744, the microprocessor determines whether or not the trip time is between T₀ and Tₐ, according to the following equation.

$${T}_{0} \leq t < {T}_{a}$$

At T₀, the initial start velocity is zero.

If so, the microprocessor moves to step 746. If not, the microprocessor moves to step 748.

At step 746, the microprocessor calculates the value of Vₐ, as previously described.

At step 747, the microprocessor sets the value of Vₘₐₓ equal to Vₐ and moves to step 758.

At step 748, the microprocessor determines whether or not the elapsed trip time is between the values of Tₐ and T_{b}, according to the following equation.

$${T}_{a} < t < {T}_{b}$$

If so, the microprocessor moves to step 750. If not, the microprocessor moves to step 754.

At step 750, the microprocessor calculates the values of Vₐ and V_{b}, as previously described.

At step 752, the microprocessor sets the value of Vₘₐₓ equal to V_{b} and moves to step 758.

At step 754, for the condition where the elapsed trip time, t, is between the values of T_{b} and T_{c}, the microprocessor calculates the values of Vₐ, V_{b} and V_{c}, as previously described.

At step 756, the microprocessor sets the value of Vₘₐₓ to V_{c}.

At step 758, the microprocessor sends the value of Vₘₐₓ to the motor as an instantaneous speed command, in order to set the motor speed.

At step 760, the microprocessor returns to step 704.

Referring to FIG. 7C, at step 762, the microprocessor retrieves the elapsed trip time, t, from memory.

At step 764, the microprocessor determines whether the elapsed time, t, is between the values of T₀ and Tₐ, according to the following equation.

$${T}_{0} \leq t < {T}_{a}$$

If so, the microprocessor moves to step 768. If not, the microprocessor moves to step 772.

At step 768, the microprocessor calculates the value of Vₐ, as previously described.

At step 770, the microprocessor sets the value of Vₘₐₓ to Vₐ and moves to step 776.

As step 772, for the condition where the elapsed trip time, t, is between the values of T_{b} and T_{c}, the microprocessor calculates the values of Vₐ and V_{b}, as previously described.

At step 774, the microprocessor sets the value of Vₘₐₓ to V_{b}.

At step 776, the value of Vₘₐₓ is sent to the motor to set the motor speed.

At step 778, the microprocessor returns to step 704.

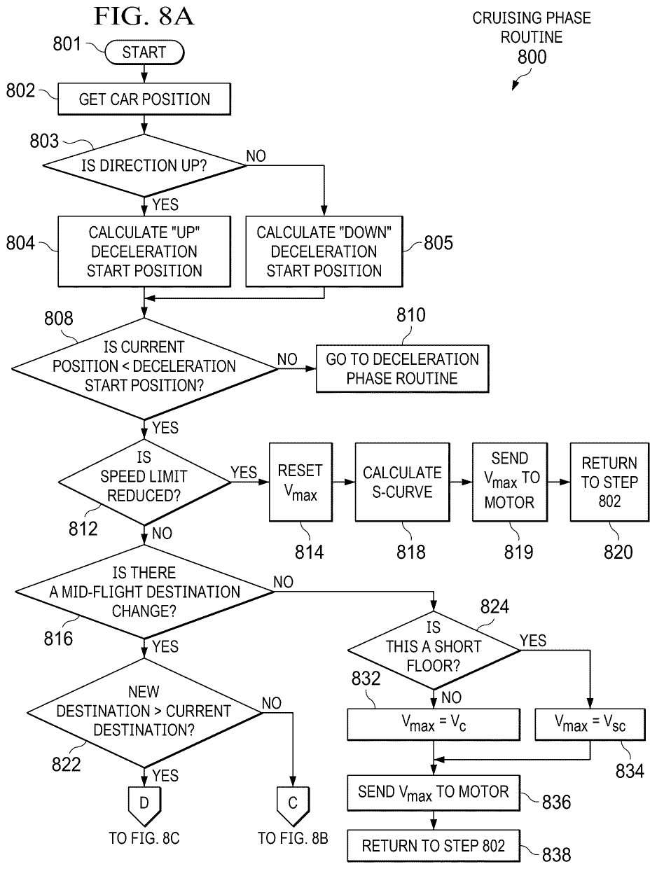

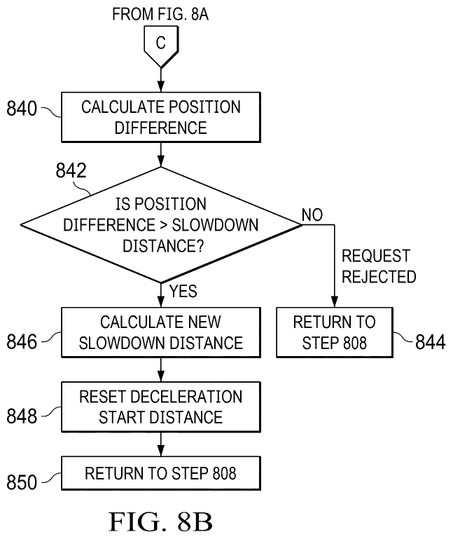

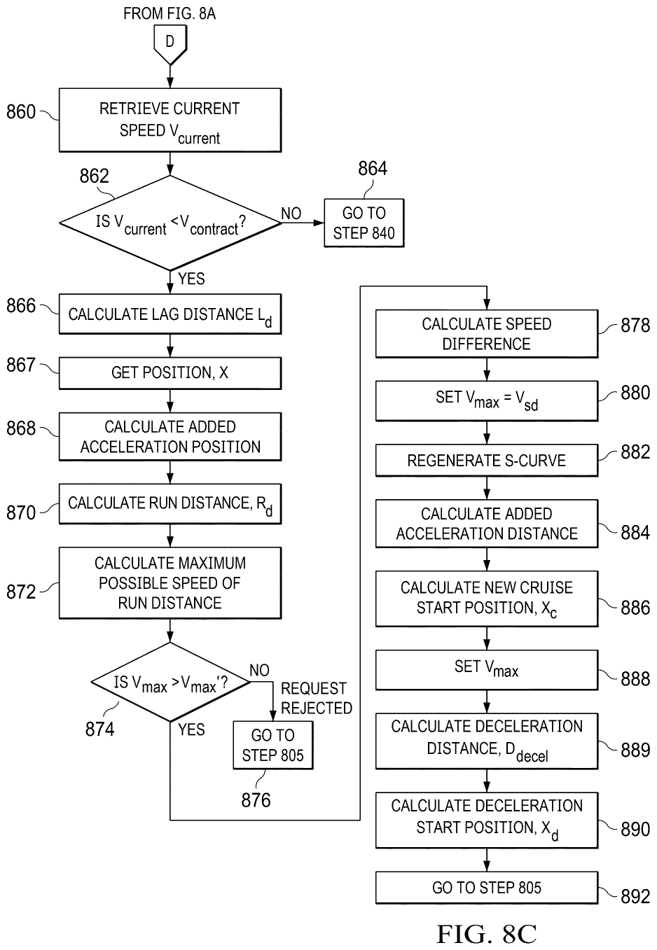

Referring then to FIGS. 8A, 8B and 8C, cruising phase routine 800 will be further described. In a preferred embodiment, this routine controls the motor speed during the cruising phase, compensating for changes in destination and reduced speed limits using the initial S-curve and modifying it when necessary.

In general, FIGS. 8A, 8B, and 8C illustrate the flow chart of the cruising phase routine of the elevator control system. During this phase, the system maintains a constant speed after completing the acceleration phase and before initiating the deceleration phase. The routine ensures the elevator travels at the designated maximum cruising speed, subject to real-time adjustments if the maximum speed is reduced or if a mid-flight destination change occurs. The routine also monitors the elevator's position to determine when to transition into the deceleration phase. If a new destination requires the elevator to accelerate further, the system recalculates the maximum speed and adjusts the S-curve accordingly. The process includes logic to handle both upward and downward travel, with distinct calculations for determining the deceleration start position based on direction. The control system continuously updates the motor speed commands to ensure smooth and efficient operation throughout the cruising phase.

At step 801, the method begins.

At step 802, the microprocessor determines the cars current position, as previously described.

At step 803, the microprocessor determines whether or not the direction of travel is up, by checking preset flags. If so, the method moves to step 804. If not, the method moves to step 805.

At step 804, the microprocessor calculates the “up” deceleration start position according to the following equation.

$${}^{‶} {Up}^{″} deceleration start position = destination position - slowdown distance$$

The method then moves to step 808.

At step 805, the microprocessor calculates the “down” deceleration start position according to the following equation.

$${}^{‶} {Down}^{″} deceleration start position = destination position + slowdown distance$$

The method then moves to step 808.

At step 808, the microprocessor determines whether or not the current position is less than the deceleration start position, using the absolute value. If not, the method moves to step 810. If so, the method moves to step 812.

At step 810, the microprocessor moves to the deceleration phase routine, as will be further described.

At step 812, the microprocessor determines whether or not the maximum speed Vₘₐₓ has been reduced, as previously described. If so, the method moves to step 814. If not, the method moves to step 816.

At step 814, the microprocessor resets the maximum speed to the reduced value of Vₘₐₓ.

At step 818, the microprocessor recalculates the S-curve using the new value of Vₘₐₓ, preferably according to method 601, as previously described.

At step 819, the microprocessor sends Vₘₐₓ to the motor.

At step 820, the microprocessor returns to step 802.

At step 816, the microprocessor determines whether or not there has been a mid-flight destination change by receiving an instruction from the car panel controller, one of the hall panel controllers or the controller keypad. When a mid-flight destination change occurs, the control system dynamically recalculates the elevator's motion profile to optimize efficiency and ride quality. Instead of adhering to the originally planned stop, the system evaluates whether the new destination requires an earlier stop or allows for continued acceleration. If the new destination is further along the travel path, the system may skip the originally planned deceleration point, allowing the elevator to overshoot the initial stop before recalculating a new acceleration start position. The system then adjusts the deceleration start position and recalculates the S-curve profile to ensure smooth motion. By dynamically modifying velocity, acceleration, and jerk parameters in real-time, the system prevents abrupt stops, maintains passenger comfort, and optimizes travel time and energy usage. If not, the method moves to step 824. If so, the method moves to step 822.

At step 822, the microprocessor determines whether or not the new destination is greater than the current destination, using the absolute value. To determine whether the newly requested destination is farther than the current destination, the microprocessor calculates the absolute difference between the current destination position and the new destination position. This ensures that the system accurately identifies whether an extended travel distance is required, regardless of the elevator's direction of travel. If not, the microprocessor moves to step 840, if so the microprocessor moves to step 860.

At step 824, the microprocessor determines whether or not the destination is a “short floor” by referring to a table in memory. If the destination is a short floor, then the microprocessor moves to step 834. If not, the microprocessor moves to step 832.

At step 834, Vₘₐₓ is set to the short floor maximum velocity, V_{sc}, and the microprocessor moves to step 836. V_{sc} is determined by referencing a table in memory. V_{sc} is always below the contact speed V_{c}.

At step 832, the value of Vₘₐₓ is set to the maximum speed V_{c}.

At step 836, the value of Vₘₐₓ is sent to the motor to set the motor speed. At step 838, the microprocessor returns to step 802.

Referring to FIG. 8B, at step 840, the microprocessor calculates a position difference according to the following equation.

$$position difference = new requested destination - current position$$

At step 842, the microprocessor decides whether or not the position difference is greater than the slowdown distance. If the position difference is equal to or less than the required slowdown distance, the system recognizes that there is insufficient room for a controlled deceleration to the requested floor. The method then moves to step 844. Otherwise, the method steps moves to step 846.

At step 844, the microprocessor rejects the request for an intermediate stop and defaults back to the cruising phase routine at step 808. This rejection mechanism ensures that the elevator does not attempt to execute an abrupt stop, which could result in passenger discomfort, increased mechanical stress, or inefficient operation.

For example, an elevator is traveling at a cruising speed of 600 feet per minute (fpm) toward Floor 12. A mid-flight request is made to stop at Floor 11. However, the system determines that there is insufficient distance to decelerate smoothly without violating jerk constraints. To prevent a sudden stop that would cause discomfort and mechanical strain, the system rejects the request and continues to Floor 12.

The rejection of stops at very close destinations provides multiple advantages in the context of the present invention. First, it enhances passenger comfort by preventing sudden deceleration events that could introduce jolts or instability. Second, it contributes to system efficiency, as unnecessary stops and starts can disrupt the flow of elevator travel and increase overall trip times. Third, it reduces mechanical wear, prolonging the lifespan of key components such as motors, brakes, and guide rails by minimizing excessive acceleration and deceleration cycles. Finally, by optimizing traffic flow, the system ensures that elevator movement remains predictable and efficient, preventing delays caused by unnecessary intermediate stops.

At step 846, the microprocessor calculates a new slowdown position according to the following equation.

$$new slowdown postion = requested destination - initial slowdown position$$

At step 848, the microprocessor resets the deceleration start position to the new slowdown position.

At step 850, the microprocessor returns to step 808.

Referring to FIG. 8C, at step 860, the microprocessor retrieves the current speed of the elevator car, V_{current}, from one of the sensors.

At step 862, the microprocessor decides whether or not the current speed V_{current}, is less than the contract speed, V_{c}. If not, the microprocessor moves to step 864. If so, the microprocessor moves to step 866.

At step 864, the method returns to step 808.

At step 866, the microprocessor calculates lag distance according to the following equation:

$$lag distance = {V}_{current} \times 1 sec$$

The lag distance is the additional distance the elevator must travel before initiating an acceleration or deceleration adjustment in response to a mid-flight destination change or speed recalculation. It accounts for the time delay required for the system to process the change and smoothly transition into the new motion profile.

At step 867, the microprocessor retrieves the current position of the elevator car from the sensors.

At step 868, the microprocessor calculates the added acceleration start position according to the following equation:

$$AASP = current car position + lag distance$$

Where:

AASP=added acceleration start position.

The starting position for added acceleration is the recalculated point where the elevator begins accelerating beyond its originally planned motion profile in response to a mid-flight destination change or speed adjustment. This happens when the system determines that increasing speed is necessary to efficiently reach a newly set destination.

At step 870, the microprocessor calculates the run distance according to the following equation:

$${R}_{d} = requested destination + AASP$$

Where:

R_{d}=run new destination position.

At step 872, the microprocessor calculates maximum speed Vₘₐₓ, required to reach the run distance by executing the calculate maximum possible speed of run distance routine 600, as previously described.

As the elevator control system dynamically adjusts its motion profile in response to mid-flight destination changes, it continuously evaluates whether modifications to the speed profile are feasible. At step 874, the system determines whether the newly calculated maximum speed, Vₘₐₓ, exceeds the originally planned maximum speed, V_{max′}, which was determined based on the initial acceleration, cruising, and deceleration parameters. If the newly computed Vₘₐₓ remains equal to or lower than V_{max′}, the system concludes that the requested change cannot be safely or efficiently accommodated. Consequently, the process advances to step 876, where the system rejects the request for an additional stop and maintains its current cruising parameters. Otherwise, the method moves to step 878.

This rejection mechanism is important to preserving the stability, efficiency, and longevity of the elevator system. Attempting to accommodate the additional stop would require an increase in speed beyond the system's pre-established operational parameters, potentially introducing abrupt motion changes that degrade ride comfort, compromise safety, and increase mechanical wear. The system is specifically designed to optimize performance by allowing only those mid-flight adjustments that align with its predefined acceleration and deceleration constraints.

Notably, even if the new maximum speed is lower than the originally planned speed, the system may still reject the request due to acceleration constraints. This counterintuitive outcome arises because reducing speed in a shortened travel distance can require a sharper deceleration profile, potentially exceeding allowable jerk or acceleration limits. The system's S-curve motion planning prioritizes smooth transitions, and abrupt adjustments to velocity, particularly rapid deceleration, can compromise ride quality, increase mechanical stress, and exceed safe operating limits.

For example, if an elevator was originally set to travel at 500 fpm to a higher floor but then receives a mid-flight request to stop at a closer floor, it may need to slow down more rapidly than its predefined deceleration parameters allow. If the system determines that achieving the new stop requires decelerating at a rate higher than permitted, it rejects the request to maintain safe and smooth operation.

By rejecting infeasible mid-flight stop requests, the system achieves several key advantages. Passenger comfort is enhanced by preventing sudden changes in acceleration that could result in jarring movements. Mechanical longevity is preserved, as frequent and excessive speed adjustments would lead to premature wear of critical components, including the motor, braking system, and guide rails. Additionally, energy efficiency is maintained, as unnecessary acceleration beyond predefined limits would increase power consumption without delivering substantial operational benefits. Finally, safety considerations are prioritized, ensuring that all speed changes occur within controlled parameters to prevent unsafe operating conditions.

At step 878, the microprocessor calculates his speed difference according to the following equation:

$$SD = {V}_{max} - {V}_{{max}^{′}}$$

Where:
SD=speed difference;
Vₘₐₓ=new maximum speed to reach run distance; and
V_{max′}=old maximum speed to reach run distance.

At step 880, the microprocessor sets Vₘₐₓ to V_{sd}.

At step 882, the microprocessor regenerates the S-curve, as previously described, using the new value of Vₘₐₓ. Upon detecting a mid-flight destination change requiring a higher maximum speed than originally planned, the control system dynamically adjusts the elevator's acceleration profile. At this step, the control system modifies the acceleration profile because the new max speed Vₘₐₓ is greater than the original max speed V_{max′} due to a mid-flight destination change. Instead of following the initial motion plan, the system generates a new acceleration S-curve, setting the velocity command Vₘₐₓ equal to the difference between the newly generated maximum speed and the original maximum speed. This adjustment ensures a smooth and controlled transition to the updated cruising speed.

By implementing an S-curve acceleration adjustment, the system prevents abrupt velocity changes, thereby reducing passenger discomfort and mechanical stress on elevator components. The modified acceleration profile allows the system to reach the newly required speed gradually, maintaining ride quality while optimizing motor efficiency.

At step 884, the microprocessor calculates the added acceleration distance using the new S-curve speed equations, as previously described.

Upon determining that the new maximum speed exceeds the original maximum speed, the control system recalculates the acceleration phase to ensure a smooth transition. This step involves computing the added acceleration distance, which represents the extra travel distance required for the elevator to reach the newly generated maximum speed using the updated acceleration S-curve profile.

The added acceleration distance is derived using kinematic motion equations, taking into account the modified acceleration and jerk parameters. The system calculates the distance as:

$${D}_{added} = \frac{{V}_{max}^{2} - {V}_{{max}^{′}}^{2}}{2 {A}_{new}}$$

Where:
D_{added}=additional distance required to complete acceleration;
Vₘₐₓ=newly generated maximum speed;
V_{max′}=originally planned maximum speed;
A_{new}=updated acceleration rate from the new S-curve.

Since the system utilizes an S-curve acceleration profile, the acceleration is not constant but varies based on a defined jerk rate. The control system accounts for this by integrating the acceleration curve over time, ensuring that the calculated added acceleration distance reflects the dynamic nature of the motion profile.

At step 886, the microprocessor calculates a new cruise start position using the equation:

$$cruise start position = AASP + {D}_{added}$$

Where:
AASP=added acceleration start position;
D_{added}=added acceleration distance.

At step 888, the microprocessor sets the maximum speed, Vₘₐₓ, to the newly generated max speed.

At step 889, upon determining that the newly generated maximum speed exceeds the originally planned velocity, the control system recalculates the deceleration phase to ensure a smooth and controlled stop at the updated destination. This step involves generating a new deceleration S-curve, where the velocity commence Vₑ is set to the newly generated maximum speed. The system adjusts the deceleration parameters using the following equation:

$${D}_{decel} = \frac{{V}_{max}^{2} - {V}_{g}^{2}}{2 {A}_{decel}}$$

Where:
D_{decel}=required deceleration distance;
Vₘₐₓ=updated cruising speed;
V_{g}=leveling speed;
A_{decel}=deceleration rate.

At step 890, the microprocessor recalculates the deceleration start position. After recalculating the deceleration phase based on the updated motion profile, the control system determines the precise point at which deceleration should begin to ensure a controlled and accurate stop at the requested destination. This is achieved by setting the deceleration start position as:

$${X}_{decel} = {X}_{destination} - {D}_{slowdown}$$

Where:
X_{destination}=is the final stop location; and
D_{slowdown}=represents the required slowdown distance based on the updated velocity and deceleration rate.

By dynamically adjusting the deceleration start position, the system prevents premature stops or overshooting, ensuring precise floor-leveling and a smooth passenger experience while optimizing energy efficiency and reducing mechanical wear. Upon determining the newly generated maximum speed, the control system recalculates the slowdown distance to ensure a smooth and accurate stop at the requested destination. The slowdown distance is computed as:

$${D}_{slowdown} = {D}_{decel} + {D}_{leveling}$$

Where:
D_{leveling}=represents a predefined leveling phase distance for precise floor alignment.

By dynamically updated the slowdown distance based on the new velocity and deceleration parameters, the system ensures an optimal balance between efficiency, ride comfort and stopping accuracy.

At step 892, the method returns to step 808.

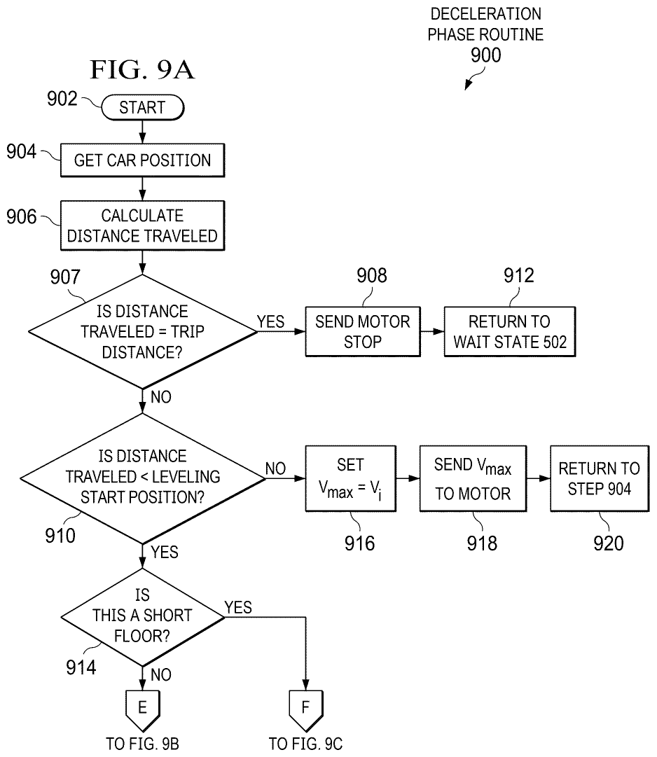

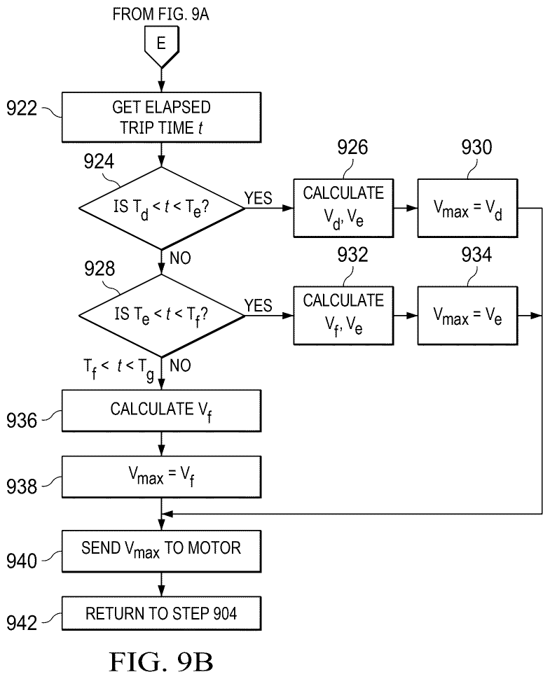

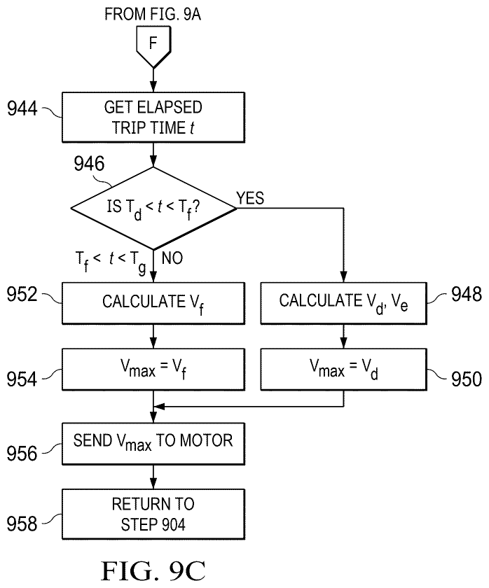

Referring then to FIGS. 9A, 9B and 9C, deceleration phase routine 900 will be further described. In a preferred embodiment, this routine controls the motor speed during the deceleration phase, compensating for changes in destination and reduced speed limits, using the initial S-curve and modifying it as necessary.

FIGS. 9A, 9B, and 9C, in general, illustrate the elevator control system's deceleration phase routine, which smoothly reduces the elevator's speed as it approaches its destination to ensure passenger comfort and precise floor alignment. The system monitors the elevator's position and calculates the distance traveled, determining whether the elevator has reached the leveling start position, where the speed is reduced to a predefined leveling speed for final floor alignment. If the leveling start position is reached, the system reduces speed; accordingly, otherwise, it continues regular deceleration. During this phase, the system calculates the elevator's speed at specific time intervals using the S-curve profile and adjusts velocity based on elapsed time and parameters such as jerk-in deceleration, jerk-out deceleration, and maximum deceleration to ensure a gradual reduction in speed. Additionally, the system identifies whether the elevator is approaching a “short floor” scenario, where the destination is reached quickly after acceleration, and uses a modified deceleration profile to ensure efficient and comfortable stopping. Throughout this process, real-time speed commands are sent to the motor to execute the final deceleration phase, ensuring smooth and precise stopping while minimizing mechanical wear.

At step 902, the method begins.

At step 904, the microprocessor determines the elevator car position by retrieving data from sensor 144 or pickup 115.

At step 906, the microprocessor calculates the distance traveled, as previously described.

At step 907, the microprocessor determines whether or not the distance traveled is equal to the trip distance. The trip distance is returned from memory and preferably is calculated according to the following equation:

$$trip distance = {X}_{g} + leveling distance$$

Where:
X_{g}=leveling start position.

If so, the method moves to step 908. If not, the method moves to step 910.

At step 908, the microprocessor sends a motor stop command to the motor. At step 912, the microprocessor returns to step 502.

At step 910, the microprocessor determines whether or not the distance traveled is less than the leveling start position.

If not, the method moves to step 916. If so, the method moves to step 914.

At step 916, the microprocessor sets the variable Vₘₐₓ to Vᵢ, the leveling speed.

At step 918, the value of Vₘₐₓ is sent to the motor to set the motor speed.

At step 920, the microprocessor returns to step 904.

At step 914, the microprocessor determines whether or not the destination is a short floor, as previously described.

If not, the method moves to step 922. If so, the method moves to step 944.

Referring to FIG. 9B, at step 922, the microprocessor retrieves the elapsed trip time, t, from memory.

At step 924, the microprocessor determines whether or not the value of, t, is between the value of Tₐ and Tₑ, according to the following equation.

$${T}_{d} < t < {T}_{e}$$

If not, the method moves to step 928. If so, the method moves to step 926.

At step 926, the microprocessor calculates the value of V_{d}, and Vₑ, as previously described.

At step 930, the microprocessor sets the value of Vₘₐₓ to Vₐ and moves to step 940.

At step 928, the microprocessor determines whether the elapsed trip time, t, is between the values of Tₑ and T_{f} according to the following equation.

$${T}_{e} < t < {T}_{f}$$

If so, the method moves to step 932. If not, the method moves to step 936.

At step 932, the microprocessor calculates the value of Vₑ and V_{f}, as previously described.

At step 934, the value of V is set to Vₑ and the method moves to step 940.

At step 936, for the condition where the elapsed trip time, t, is between the values of Tr and T_{g}, the microprocessor calculates the value of V_{f}, as previously described.

At step 938, the value Vₘₐₓ is set to Vᵣ and the microprocessor moves to step 940.

At step 940, the value of Vₘₐₓ is sent to the motor to set the motor speed.

At step 942, the method returns to step 904.

Referring to FIG. 9C, at step 944, the microprocessor retrieves the elapsed trip time, t.

At step 946, the microprocessor determines whether the elapsed trip time is between the value of Tₐ and Tₑ according to the following equation.

$${T}_{0} < t < {T}_{f}$$

If so, the microprocessor moves to step 948. If not, the microprocessor moves to step 952.

At step 948, the microprocessor calculates the values of Vₐ and Vₑ, as previously described.

At step 950, the microprocessor sets the value of Vₘₐₓ to Vₐ and moves to step 956.

At step 952, for the condition where the elapsed trip time, t, is between the values of T_{f} and T_{g}, the microprocessor calculates the value of V_{f}, as previously described.

At step 954, the microprocessor sets the value of Vₘₐₓ to Vᵣ and moves to step 956.

At step 956, the value of Vₘₐₓ is sent to the motor to set the motor speed. At step 958, the microprocessor returns to step 904.

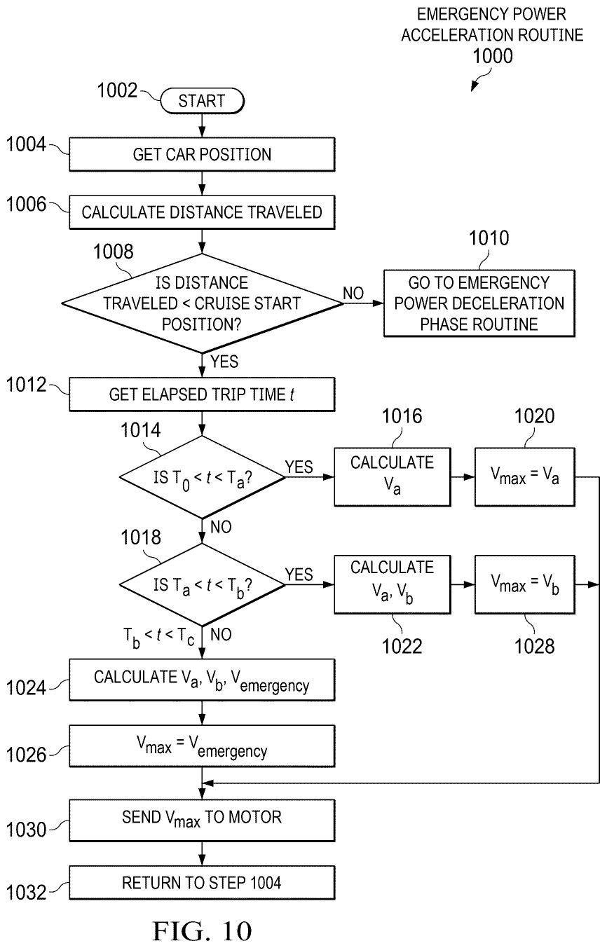

Referring then to FIG. 10, emergency power acceleration routine 1000 will be further described. In a preferred embodiment, this routine controls the motor speed during the acceleration phase when the maximum speed, and other parameters may be reduced or modified to facilitate reduced power consumption from batteries or back-up generators.

At step 1002, the method begins.

At step 1004, the microprocessor retrieves the value of the elevator car position by polling sensor 144 or pickup 115.

At step 1006, the microprocessor calculates the distance traveled, as previously described.

At step 1008, the microprocessor determines whether or not the distance traveled is less than the cruise start position. If not, the microprocessor moves to step 1010. If so, the microprocessor moves to step 1012.

At step 1010, the microprocessor moves to the emergency power deceleration phase routine, as will be further described.

At step 1012, the microprocessor retrieves the elapsed trip time, t.

At step 1014, the microprocessor determines whether or not the elapsed trip time, t, is between the values of T₀ and Tₐ according to the following equation.

$${T}_{0} \leq t < {T}_{a}$$

If so, the microprocessor moves to step 1016. If not, the microprocessor moves to step 1018.

At step 1016, the microprocessor calculates the value of Vₐ, as previously described.

At step 1020, the microprocessor sets the value of Vₘₐₓ to Vₐ and moves to step 1030.

At step 1018, the microprocessor determines whether or not the elapsed trip time, t, is between the values of Tₐ and T_{b} according to the following equation.

$${T}_{a} < t < {T}_{b}$$

If so, the microprocessor moves to step 1022. If not, the microprocessor moves to step 1024.

At step 1022, the microprocessor calculates the value of Vₐ and V_{b}, as previously described.

At step 1028, the microprocessor sets the value of Vₘₐₓ to V_{b}, then moves to step 1030.

At step 1024, the microprocessor for the condition where the elapsed trip time, t, is between the values of T_{b} and T_{c}, the microprocessor calculates the value of Vₐ, V_{b} and V_{c}, as previously described. Vₘₐₓ in this instance is set as V_{emergency}, the maximum velocity for emergency conditions.

At step 1026, the microprocessor sets the value of Vₘₐₓ to V_{emergency} and moves to step 1030.

At step 1030, the value of Vₘₐₓ is sent to the motor set the motor speed. At step 1032, the microprocessor returns to step 1004.

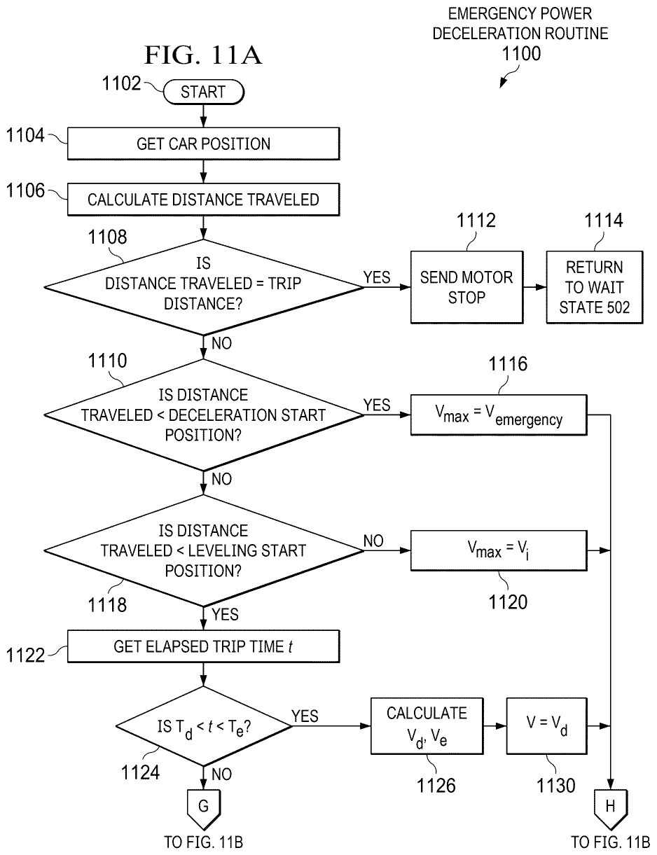

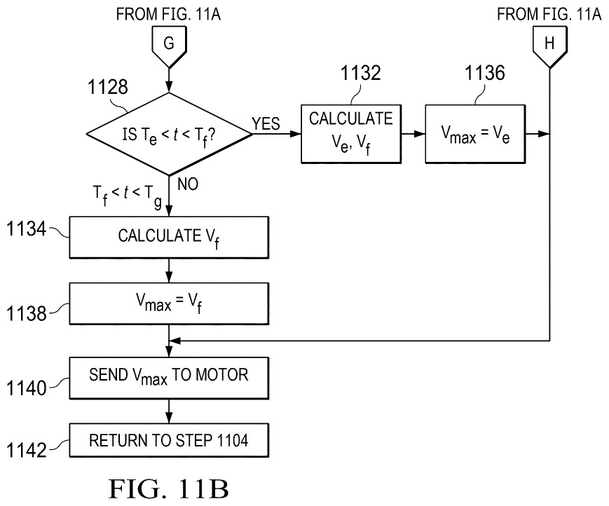

Referring to FIGS. 11A and 11B, emergency power deceleration routine 1100 will be further described. In a preferred embodiment, this routine controls the motor speed during the cruising and deceleration phases when the maximum speed and other parameters may be reduced or modified to facilitate reduced power consumption.

At step 1102, the method begins.

At step 1104, the microprocessor retrieves the elevator car position by polling sensor 144 or pickup 115.

At step 1106, the microprocessor calculates the distance traveled, as previously described.

At step 1108, the microprocessor determines whether or not the distance traveled is equal to the trip distance. If not, the method moves to step 1110. If so, the method moves to step 1112.

At step 1112, the microprocessor sends a stop command to the motor.

At step 1114, the microprocessor returns to step 502.

At step 1110, the microprocessor determines whether or not the distance traveled is less than the deceleration start position. If so, the microprocessor moves to step 1116. If not, the microprocessor moves to step 1118.

At step 1116, the value of Vₘₐₓ is set to the value of V_{emergency} in memory and the method moves to step 1140.

At step 1118, the microprocessor determines whether or not the distance traveled is less than the leveling start position. If not, the microprocessor moves to step 1120. If so, the microprocessor moves to step 1122.

At step 1120, the microprocessor sets the value of Vₘₐₓ to Vᵢ, the leveling speed, and moves to step 1140.

At step 1122, the microprocessor retrieves the elapsed trip time, t, from memory.

At step 1124, the microprocessor determines whether or not the elapsed trip time, t, is between the values of Tₐ and Tₑ, according to the following equation.

$${T}_{0} < t < {T}_{e}$$

If so, the microprocessor moves to step 1126. If not, the microprocessor moves to step 1128.

At step 1126, the microprocessor calculates the value of Vₐ and Vₑ, as previously described.

At step 1130, the microprocessor sets the value of Vₘₐₓ to Vₐ and moves to step 1140.

Referring to FIG. 11B, at step 1128, the microprocessor determines whether or not the value of the elapsed trip time, t, is between the value of Tₑ and T_{f}, according to the following equation.

$${T}_{e} < t < {T}_{f}$$

If so, the microprocessor moves to step 1132. If not, the microprocessor moves to step 1134.

At step 1132, the microprocessor calculates the values of Vₑ and V_{f}, as previously described.

At step 1136, the microprocessor sets the value of Vₘₐₓ to Vₑ and moves to step 1140.

At step 1134, the microprocessor for the condition where the elapsed trip time, t, is between the values of T_{f} and T_{g} the microprocessor calculates the value of V_{f}, as previously described.

At step 1138, the microprocessor sets the value of Vₘₐₓ to V_{f} and moves to step 1140.

At step 1140, the value of Vₘₐₓ is sent to the motor to set the motor speed. At step 1142, the microprocessor returns to step 1104.

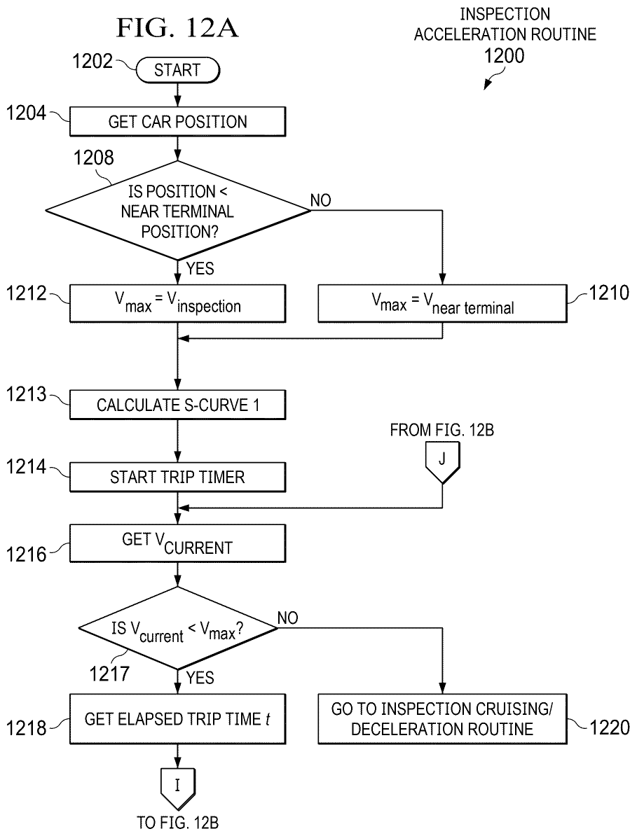

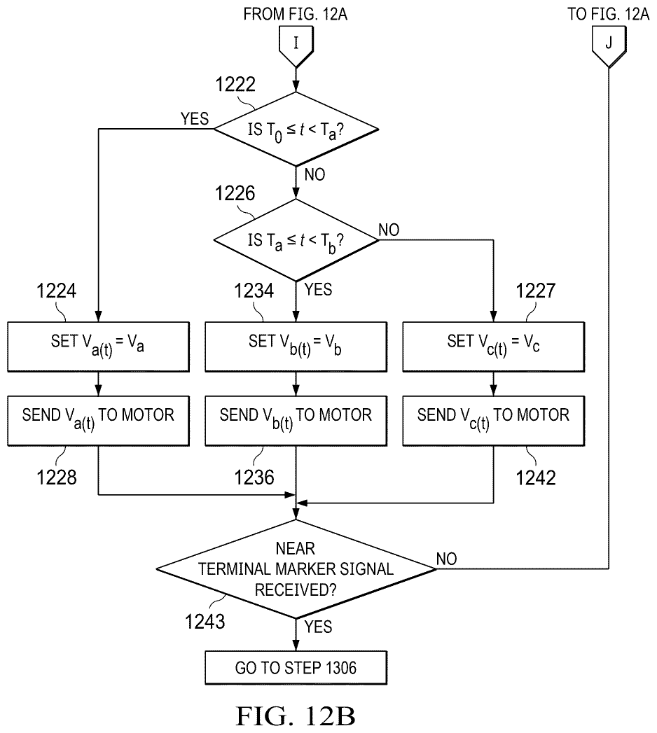

Referring then to FIGS. 12A and 12B, inspection acceleration routine 1200 will be further described. In a preferred embodiment, this routine controls the motor speed during the acceleration phase, when the maximum speed, and other parameters may be reduced or modified to facilitate elevator inspection procedures when heightened safety is a paramount concern.

The inspection profile routine outlines a control process for managing the elevator's motion at low speeds during inspection and maintenance operations. It ensures safe and precise movement by implementing a sequence of acceleration, cruising, and deceleration phases, each monitored and adjusted in real-time. The system begins by initializing inspection-specific parameters, including a preferred maximum cruising speed of 50 fpm and controlled deceleration rates. During the acceleration phase, the elevator gradually increases speed following a jerk-controlled S-curve profile until it reaches the predefined inspection speed.

Once cruising speed is achieved, the system continuously monitors position, ensuring stable and predictable motion. When nearing the target destination, the system transitions to the deceleration phase, progressively reducing speed to align with the leveling zone using reduction speed calculations based on elapsed time and deceleration rate. Magnetic markers positioned at near-terminal and terminal locations provide absolute position confirmation, enabling precise control of the deceleration and leveling phases.

The routine ultimately ensures that the elevator halts at the exact target position, allowing for safe and accurate floor alignment. This logic is designed to prioritize technician safety, eliminate abrupt changes in motion, and provide real-time adaptability to inspection requirements, differing significantly from standard operational profiles that prioritize speed and efficiency.

The method begins at step 1202.

At step 1204, the microprocessor retrieves the relative elevator car position by polling sensor 144 or pickup 115.

At step 1208, the microprocessor determines whether or not the distance traveled is less than the “near terminal position”. In a preferred embodiment, the near terminal position are positions within about 2 inches to about 2 feet of the top and the bottom of the elevator travel. Near terminal sensors are located in the elector shaft each at of those positions as well. The positions of these sensors are dependent on the mechanics of the particular elevator involved.

If not, the microprocessor moves to step 1210. If so, the microprocessor moves to step 1212.

At step 1210, the microprocessor resets the value of Vₘₐₓ to V_{near terminal} and moves to step 1213.

At step 1212, the microprocessor resets the value of Vₘₐₓ to V_{inspection} and moves to step 1213.

At step 1213, the microprocessor recalculates the S-curve using the new value of Vₘₐₓ. In a preferred embodiment the S-curve is recalculated according to method 601. For the purposes of method 1200, the S-curve values are referred to as “S-curve 1” values. At this step the values, Vₐ, the velocity at the beginning of constant acceleration, V_{b}, the velocity at the end of constant acceleration, V_{c} and V_{d}, maximum possible cruising speed are calculated. No deceleration profile is calculated since the destination is not yet known.

At step 1214, the microprocessor starts the trip timer.

At step 1216, the microprocessor retrieves the current speed of the car, V_{current}, from the sensors.

At step 1217, the microprocessor determines whether or not the speed, V_{current}, is less than Vₘₐₓ. If so, the microprocessor moves to step 1218. If not, the microprocessor moves to step 1220.

At step 1218, the microprocessor retrieves the elapsed trip time, t, from the trip timer.

At step 1220, the microprocessor moves to the inspection cruising/deceleration routine, as will be further described.

At step 1222, the microprocessor determines whether or not the value of, t, is between the value of T₀ and Tₐ, according to the following equation.

$${T}_{0} \leq t < {T}_{a}$$

Where:
T₀=is zero; and
Tₐ=time at the beginning of constant acceleration.

If so, the microprocessor moves to step 1224. If not, the microprocessor moves to step 1226.

At step 1224, the microprocessor sets the instantaneous value Vₐ₍ₜ₎ to Vₐ and moves to step 1228.

At step 1226, the microprocessor determines whether or not the value of, t, is between the values of Tₐ and T_{b}, according to the following equation.

$${T}_{a} \leq t < {T}_{b}$$

Where:
Tₐ=time at beginning of constant acceleration;
T_{b}=time at end of constant acceleration.

If so, the microprocessor moves to step 1234. If not, the microprocessor moves to step 1227.

At step 1234, the microprocessor sets the instantaneous value V_{b(t)} to V_{b} and moves to step 1236.

At step 1227, the microprocessor sets the instantaneous value V_{b(t)} to V_{b} and moves to step 1242.

At step 1228, the microprocessor sends the value Vₐ₍ₜ₎ is sent to the motor and moves to step 1243.

At step 1236, the microprocessor sends the value of V_{b(t)} to the motor, and moves to step 1243.

At step 1242, the microprocessor sends the value of V_{c(t)} to the motor and moves to step 1243.

At step 1243, the microprocessor determines whether or not a near terminal marker signal has been received from the sensors.

If so, the microprocessor moves to step 1306, as will be further described. If not, the microprocessor returns to step 1216.

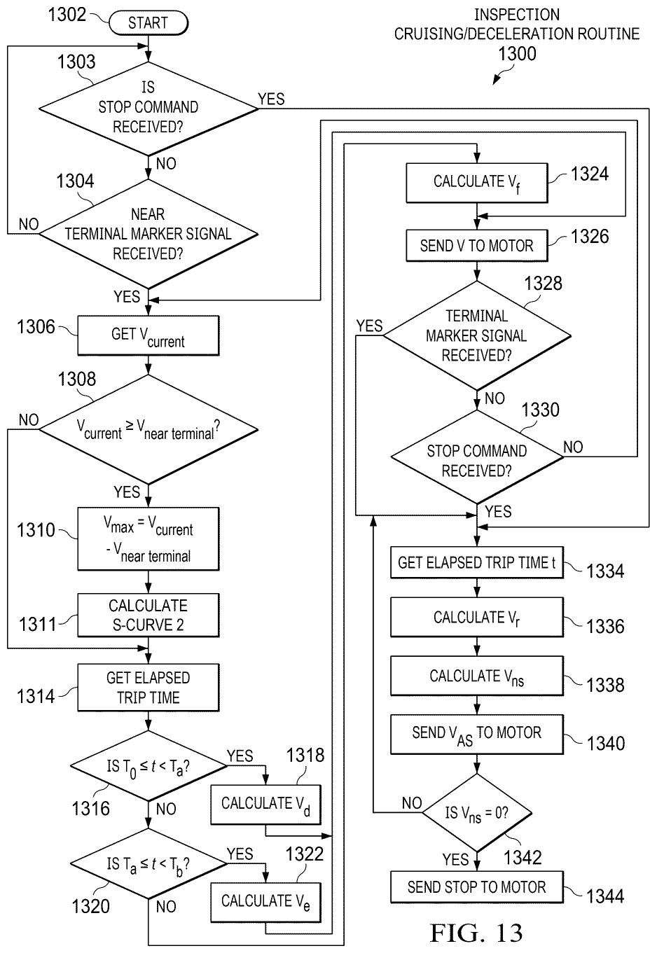

Referring then to FIG. 13, inspection cruising deceleration routine 1300 will be further described.

In general, FIG. 13 illustrates the inspection cruising deceleration routine, which ensures the elevator decelerates smoothly and safely as it approaches its terminal position during inspection mode. The process begins by monitoring the elevator's position relative to near terminal markers, which trigger a gradual speed reduction. If the elevator receives a stop command, the system calculates the remaining distance and time, progressively decreasing speed to ensure a controlled stop. Throughout the routine, the elevator's speed is adjusted in real-time based on preset velocity limits and deceleration rates, prioritizing precise floor alignment and minimizing abrupt movements for technician safety.

At step 1302, the method begins.

At step 1303, the microprocessor determines whether or not a step command has been received from the control panel. If so, the microprocessor moves to step 1334. If not, the microprocessor moves to step 1304.

At step 1304, the microprocessor determines whether or not a signal has been received from the near terminal marker. If not, the method returns to step 1303. If so, the method moves to step 1306.

At step 1306, the value of the cars current velocity, V_{current}, is retrieved from the sensors.

At step 1308, the microprocessor determines whether or not the current velocity of the car, V_{current}, is greater than V_{near terminal}. If so, the method moves to 1310. If not, the method moves to step 1314.

At step 1310, the value of Vₘₐₓ, for S-curve calculations, is set according to the following equation.

$${V}_{max} = {V}_{current} - {V}_{near terminal}$$

At step 1311, the S-curve is recalculated. For the purposes of method 1200, these S-curve values are referred to as “S-curve 2” values. At this step, the values of Vₐ, the instantaneous velocity at the beginning of constant acceleration, V_{b}, the instantaneous velocity at the end of constant acceleration, Vₑ and V_{d}, the instantaneous cruising speed, Vₑ, the velocity at the beginning of constant deceleration, and V_{f}, the velocity at the end of constant deceleration are assigned the values V₍ₜ₎ₐ, V_{(t)b}, V_{(t)c}, V_{(t)d}, V₍ₜ₎ₑ, and V_{(t)f}, respectively, and are referred to as “instantaneous” values from S-curve 2.

At step 1314, the microprocessor retrieves the elapsed trip time, t, from memory.

At step 1316, the microprocessor determines whether or not the value of tis between the values of T₀ and Tₐ, according to the following equation:

$${T}_{0} \leq t < {T}_{a}$$

Where:
T₀=velocity is zero; and
Tₐ=time at beginning of constant acceleration.

If so, the microprocessor moves to step 1318. If not, the microprocessor moves to step 1320.

At step 1318, the microprocessor calculates the value of V_{d}, according to the following equation:

$${V}_{d} = {V}_{current} - {V}_{a ( t )}$$

Where:
Vₐ=maximum possible cruising speed for inspection;
V_{current}=current velocity of elevator car; and
Vₐ₍ₜ₎=instantaneous velocity at beginning of constant acceleration calculated from S-curve 1 or S-curve 2, whichever has been calculated most recently.

The microprocessor then moves to step 1326.

At step 1320, the microprocessor determines whether or not the elapsed trip time is between the values of Tₐ and T_{b}, according to the following equation.

$${T}_{a} \leq t < {T}_{b}$$

Where:
Tₐ=time at beginning of constant acceleration; and
T_{b}=time at end of constant acceleration.

If so, the microprocessor moves to step 1322. If not, the microprocessor moves to step 1324.

At step 1322, the microprocessor calculates the value of Vₑ, according to the flowing equation:

$${V}_{e} = {V}_{d ( t )} - {V}_{b ( t )}$$

Where:
Vₑ=velocity at beginning of constant deceleration;
Vₐ₍ₜ₎=instantaneous cruising speed calculated from S-curve 1 or S-curve 2, whichever has been calculated most recently; and
V_{b(t)}=instantaneous velocity at end of constant acceleration calculated from S-curve 1 or S-curve 2, whichever has been calculated most recently.

The microprocessor then moves to step 1326.

At step 1324, the condition where the elapsed trip time, t, is between the values of T_{b} and T_{c}, the microprocessor calculates the value of V_{f}, according to the following equation:

$${V}_{f} = {V}_{e ( t )} - {V}_{c ( t )}$$

Where:
V_{f}=velocity at end of constant deceleration;
Vₑ₍ₜ₎=Vₑ₍ₜ₎ instantaneous velocity at the beginning of constant deceleration calculated from S-curve 1 or S-curve 2, whichever has been calculated most recently; and
V_{c(t)}=instantaneous cruising speed calculated from S-curve 1 or S-curve 2 whichever has been calculated most recently.

The microprocessor moves to step 1326.

At step 1326, the microprocessor sends the value of V_{d}, Vₑ or V_{f} to the motor to set the motor speed.

At step 1328, the microprocessor determines whether or not a terminal marker signal is received from the sensors. If so, the microprocessor moves to step 1334. If not, the microprocessor returns to step 1306.

At step 1330, microprocessor determines whether or not a stop command has been received from the control panel. If so, the microprocessor moves to step 1334. If not, the microprocessor returns to step 1306.

At step 1334, the microprocessor retrieves the elapsed trip time, t, from memory.

At step 1336, the microprocessor determines an increasing speed reduction value, Vᵣ, according to the following equation.

$${V}_{r} = D \times {t}_{s}$$

Where:
D=deceleration value in the inspection profile; and
tₛ=elapsed time since the beginning of deceleration.

At step 1338, the microprocessor iteratively calculates a new speed, Vₙₛ, according to the following equation.

$${V}_{ns} = {V}_{current} - {V}_{r}$$

Where:
Vᵣ=V_{speed reduction}; and
V_{current}=current speed.

At step 1340, the microprocessor sends the value of Vₙₛ to the motor to set the motor speed. As the value of value of Vₙₛ decreases with each iteration the car decelerates in a controlled manner.

At step 1342, the microprocessor determines whether or not the value of Vₙₛ is zero. If so, the microprocessor moves to step 1334. If not, the microprocessor returns to step 1306.

At step 1344, the microprocessor sets the motor speed to zero.

1. A multiphasic traction elevator control system for an elevator car in an elevator shaft, comprising:
a central controller, configured to generate a set of speed commands for the elevator car based on a set of profiles;
a motor room board, operatively connected to the central controller, and configured to relay the set of speed commands to a traction drive motor, operatively connected to the elevator car;
a car panel controller, operatively connected to the central controller, configured to receive a set of user inputs and transmit a set of destination requests to the central controller, related to the set of user inputs;
a hall panel controller, operatively connected to the central controller, configured to receive a set of call signals and transmit the set of call signals to the central controller;
a position sensor, operatively connected to the central controller, configured to monitor a velocity and a position of the elevator car within the elevator shaft;
a communication interface operatively connected to the central controller, the motor room board, and the hall panel controller; and
a motion planning module, stored in a memory unit of the central controller, and when executed by the central controller, causes the system to:
calculate a first S-curve motion profile, comprising an acceleration phase, a cruising phase, and a deceleration phase;
adjust a maximum possible speed, Vₘₐₓ, based on a travel distance;
accommodate a mid-flight destination change by recalculating a velocity profile; and
execute a stop rejection mechanism that prevents an intermediate stop if a requested floor is too close to a current position of the elevator car, or requires exceeding a predefined acceleration threshold for the elevator car.

2. The multiphasic traction elevator control system of claim 1, wherein the motion planning module further causes the system to:
iteratively refine the maximum possible speed before each trip of the elevator car based on the travel distance.

3. The multiphasic traction elevator control system of claim 1, wherein the set of profiles further comprises:
a normal profile for execution during a set of standard operations;
a short profile for execution in a set of short floor operations;
an emergency power profile for execution during a power failure; and
an inspection profile for execution during a maintenance procedure.

4. The multiphasic traction elevator control system of claim 3, wherein the motion planning module further comprises:
a jerk-in acceleration parameter, a jerk-out acceleration parameter, a jerk-in deceleration parameter, and a jerk-out deceleration parameter for each of the normal profile, the short profile, the emergency power profile, and the inspection profile.

5. The multiphasic traction elevator control system of claim 3, wherein the emergency power profile limits acceleration of the elevator car during the power failure.

6. The multiphasic traction elevator control system of claim 3, wherein, during implementation of the inspection profile, the motion planning module further causes the system to:
retrieve the position of the elevator car from the position sensor;
set the maximum possible speed, Vₘₐₓ, based on proximity of the elevator car to a near terminal position;
calculate a second S-curve motion profile based on the maximum possible speed, Vₘₐₓ;
wherein the second S-curve motion profile includes at least a first set of instantaneous velocity values;
start a trip timer;
retrieve a velocity, V, of the elevator car from the position sensor;
if the velocity, V, is not less than the maximum possible speed, Vₘₐₓ, then execute an inspection cruising/deceleration routine; and
if the velocity, V, is less than the maximum possible speed, Vₘₐₓ, then:
retrieve an elapsed trip time, t from the trip timer; and
based on the elapsed trip time, t, send one of V₍ₜ₎ₐ, V_{(t)b}, and V_{(t)c}, from the first set of instantaneous velocity values to the traction drive motor.

7. The multiphasic traction elevator control system of claim 6, wherein the inspection cruising/deceleration routine further causes the system to:
determine whether or not a near terminal marker signal has been received from the position sensor; and
if the near terminal marker signal is received, then:
retrieve the velocity, V, from the position sensor;
determine whether or not the velocity, V, is greater than a near terminal velocity, V_{near terminal};
if the velocity, V, is greater than the near terminal velocity, V_{near terminal}, then subtract the near terminal velocity, V_{near terminal} from the velocity, V, to determine a new maximum velocity, Vₘₐₓ new,
calculate a third S-curve motion profile based on the new maximum velocity, V_{max new};
wherein the third S-curve motion profile includes at least a second set of instantaneous velocity values;
retrieve the elapsed trip time, t;
based on the elapsed trip time, t, calculate one of a velocity V_{d}, maximum possible cruising speed for inspection, a velocity Vₑ, at a start of constant deceleration, and a velocity V_{f}, at an end of constant deceleration, based on the second set of instantaneous velocity values; and
send one of V_{d}, Vₑ, and V_{f}, to the traction drive motor.

8. The multiphasic traction elevator control system of claim 6, wherein the inspection cruising/deceleration routine further causes the system to:
determine whether or not a terminal marker signal has been received; and
if so, then:
retrieve the elapsed trip time, t;
calculate a speed reduction value, Vᵣ, based on the elapsed trip time, t;
iteratively calculate a new speed, Vₙₛ based on the speed reduction value Vᵣ; and
stop the traction drive motor when the new speed, Vₙₛ reaches zero.

9. The multiphasic traction elevator control system of claim 7, wherein the inspection cruising/deceleration routine further causes the system to:
if the velocity, V, is not greater than the near terminal velocity, V_{near terminal}, then;
retrieve the elapsed trip time, t;
based on the elapsed trip time, t, calculate one of the velocity V_{d}, maximum possible cruising speed for inspection, the velocity Vₑ, at the start of constant deceleration, and the velocity V_{f}, at the end of constant deceleration, based on the first set of instantaneous velocity values; and
send one of V_{d}, Vₑ, and V_{f}, to the traction drive motor.

10. The multiphasic traction elevator control system of claim 1, wherein the motion planning module further causes the system to:
modify the first S-curve motion profile in response to the mid-flight destination change, thereby adjusting the acceleration phase and the deceleration phase.

11. The multiphasic traction elevator control system of claim 1, wherein the stop rejection mechanism prevents the intermediate stop if the intermediate stop is too close to the current position of the elevator car, resulting in an inefficient deceleration distance, or, accommodating the intermediate stop would require exceeding a maximum allowable acceleration or a maximal allowable speed.

12. The multiphasic traction elevator control system of claim 1, wherein the motion planning module further comprises:
a precision floor leveling algorithm configured to:
determine a real-time position of the elevator car with a set of absolute position markers; and
adjust a leveling speed, vᵢ, to ensure a near zero deviation from a target stop position.

13. The multiphasic traction elevator control system of claim 1, wherein the communication interface transmits a set of speed updates and a set of motion updates at intervals of approximately 10 milliseconds.

14. A method of controlling a traction elevator system for an elevator car comprising:
receiving a set of real-time sensor inputs from a set of sensors, at a central controller;
generating a set of speed commands, based on the set of real-time sensor inputs and a motion profile;
transmitting the set of speed commands to a motor room board;
relaying the set of speed commands to a traction drive motor, connected to the elevator car;
processing a user input from a car panel controller or a call signal from a hall panel controller to determine a destination of the elevator car;
continuously monitoring an elevator car position and an elevator car velocity using the set of real-time sensor inputs to derive a set of motion data;
communicating the set of motion data across a communication network connecting the central controller, the motor room board, the car panel controller and the hall panel controller; and
executing a motion planning routine, stored in a memory of the central controller, to:
calculate a first S-curve motion profile with an acceleration phase, a cruising phase and a deceleration phase;
determine a maximum feasible speed based on a trip distance;
adjust a set of motion parameters in response to a mid-flight destination change; and
implement a stop rejection mechanism to prevent intermediate stops of the elevator car when a requested stop is too close to a current position of the elevator car or requires exceeding a predefined acceleration limit for the elevator car.

15. The method of claim 14, further comprising:
iteratively refining the maximum feasible speed based on an acceleration time and an operational constraint.

16. The method of claim 14, further comprising:
wherein the motion profile is automatically selected from a set of predefined speed management profiles, further comprising:
a normal profile, a short distance profile, an emergency profile, and an inspection profile.

17. The method of claim 16, further comprising:
reducing an acceleration and a cruising speed of the elevator car in response to implementation of the emergency profile.

18. The method of claim 16, wherein the inspection profile further comprises:
retrieving a position of the elevator car from the set of sensors;
setting a maximum possible speed, Vₘₐₓ, based on proximity of the elevator car to a near terminal position;
calculating a second S-curve motion profile based on the maximum possible speed, Vₘₐₓ,
wherein the second S-curve motion profile includes at least a first set of instantaneous velocity values;
starting a trip timer;
retrieving a velocity, V, of the elevator car from the set of sensors;
if the velocity, V, is not less than the maximum possible speed, Vₘₐₓ, then executing an inspection cruising/deceleration routine;
if the velocity, V, is less than the maximum possible speed, Vₘₐₓ, then:
retrieving an elapsed trip time, t from the trip timer; and
based on the elapsed trip time, t, send one of V₍ₜ₎ₐ, V_{(t)b}, and V_{(t)c}, from the first set of instantaneous velocity values to the traction drive motor.

19. The method of claim 18, wherein the inspection cruising/deceleration routine further comprises:
determining whether or not a near terminal marker signal has been received from the set of sensors; and
if the near terminal marker signal has been received, then:
retrieving the velocity, V, of the elevator car from memory;
determining whether or not the velocity, V, of the elevator car is greater than a near terminal velocity, V_{near terminal};
if so, then subtracting the near terminal velocity, V_{near terminal} from the velocity, V, of the elevator car to determine a new maximum velocity, V_{max new};
calculating a third S-curve motion profile based on the new maximum velocity, V_{max new};
wherein the third S-curve motion profile includes at least a second set of instantaneous velocity values;
retrieving the elapsed trip time, t;
based on the elapsed trip time, t, calculate one of a velocity, V_{d}, maximum possible cruising speed for inspection, a velocity Vₑ, at a start of constant deceleration, and a velocity V_{f}, at an end of constant deceleration, based on the second set of instantaneous velocity values; and
send one of V_{d}, Vₑ, and V_{f}, to the traction drive motor.

20. The method of claim 19, wherein the inspection cruising/deceleration routine further comprises:
if a terminal marker signal or a stop command is received then:
retrieving the elapsed trip time, t;
calculating a speed reduction value Vᵣ, based on the elapsed trip time, t;
iteratively calculating a new speed, Vₙₛ based on the speed reduction value Vᵣ; and
stopping the traction drive motor when the new speed, Vₙₛ reaches zero.

21. The method of claim 19, wherein the inspection cruising/deceleration routine further comprises:
if the velocity, V, is not greater than the near terminal velocity, V_{near terminal};
then retrieving the elapsed trip time, t; and
based on the elapsed trip time, t, calculating one of the velocity V_{d}, maximum possible cruising speed for inspection, the velocity Vₑ, at the start of constant deceleration, and the velocity V_{f}, at the end of constant deceleration, based on the first set of instantaneous velocity values.

22. The method of claim 14, further comprising:
modifying the first S-curve motion profile in response to the mid-flight destination change by adjusting the acceleration phase and the deceleration phase.

23. The method of claim 14, further comprising:
executing a stop-rejection mechanism that prevents an intermediate stop of the elevator car when:
the intermediate stop is too close to the current position of the elevator car, resulting in an insufficient deceleration distance; or
accommodating the intermediate stop would require exceeding a maximum allowable acceleration threshold for the elevator car.

24. The method of claim 14, further comprising:
continuously comparing a real-time position of the elevator car against an absolute position marker; and
adjusting a leveling speed to achieve a near zero deviation from a target stop position.

25. The method of claim 14, further comprising:
dynamically adjusting a set of jerk-in parameters and a set of jerk-out parameters during the acceleration phase and the deceleration phase.

26. The method of claim 14, further comprising:
sending a set of speed updates and a set of motion updates from the set of real-time sensor inputs across the communication network at intervals of about 10 milliseconds.

27. The method of claim 14, wherein the motion planning routine is further configured to:
independently control jerk-in values and jerk-out values during the acceleration phase and the deceleration phase to reduce mechanical stress on at least one of a traction sheave, a motor, or a brake assembly of the traction elevator system.

28. The method of claim 14, wherein determining the maximum feasible speed further comprises:
calculating a ramp-up distance and a slowdown distance based on the first S-curve motion profile;
determining whether a sum of the ramp-up distance and the slowdown distance exceeds the trip distance; and
if the sum exceeds the trip distance, iteratively reducing the maximum feasible speed until the sum is within the trip distance.

29. The method of claim 14, further comprising:
selecting the motion profile from a set of predefined speed management profiles based on at least one of: power availability, the trip distance, or an operational mode.
